(19) United States
(12) Patent Application Publication
(10) Pub. No.: US 2026/0340421 A1
(43) Pub. Date: Oct. 29, 2026

(54) HARDWARE-ASSISTED RUN-TIME DYNAMIC RECONFIGURATION OF COMPLEX DATA MOVEMENT TASKS

(71) Applicant: Intel Products IP LLC, Santa Clara, CA (US)

(72) Inventors: Andrea Deidda, Leixlip (IE); Alfonso Tarazona Martinez, Celbridge (IE)

(73) Assignee: Intel Products IP LLC, Santa Clara, CA (US)

(21) Appl. No.: 19/702,221

(22) Filed: Jun. 9, 2026

Related U.S. Application Data
(60) Provisional application No. 63/864,914, filed on Aug. 15, 2025.

(51) Int. Cl. G06N 3/10

(52) U.S. Cl. CPC G06N 3/10

(57) ABSTRACT

A neural network accelerator includes a data movement engine to patch task descriptors at runtime. A link agent circuit fetches a task descriptor encoding a data movement operation and detects, e.g., based on an enable indicator, that a descriptor field stores a pointer to a memory location rather than a compile-time value. The link agent circuit reads a runtime value from the memory location and generates a patched task descriptor by replacing the field with the runtime value or by computing a resolved value from the runtime value and a descriptor-stored value. A channel circuit then executes the data movement operation according to the patched task descriptor. Runtime values may be derived from inference-time input parameters and may be shared across multiple descriptors through a parameter table. The approach enables efficient dynamic transfer sizing, dimensionality adjustment, address relocation, or task skipping without modifying stored descriptors.

### PRIORITY APPLICATION

This patent application claims priority to and/or receives benefit from U.S. Provisional Application No. 63/864,914, filed on 15 Aug. 2025, titled “HARDWARE-ASSISTED RUN-TIME DYNAMIC RECONFIGURATION OF COMPLEX DATA MOVEMENT TASKS” (Docket No. AG7236-Z). The US Provisional Application is hereby incorporated by reference in its entirety.

### BACKGROUND

Hardware accelerators, such as neural processing units (NPUs), graphics processing units, and other specialized computing devices, are increasingly used to execute workloads that benefit from high parallelism and low-latency data access. These accelerators often include compute engines that operate on data stored in local or internal memory, while separate data movement hardware transfers data between the internal memory and external memory. Coordinating these compute and data movement operations is important for performance, power efficiency, and resource utilization.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates a neural network (NN) hardware accelerator having a data movement engine with runtime task descriptor field patching integrated therein, according to some examples of the disclosure.

FIG. 2 illustrates a linked list of data movement tasks, according to some examples of the disclosure.

FIG. 3 illustrates a lifecycle of a data movement task through a data movement engine, according to some examples of the disclosure.

FIG. 4 illustrates a link agent and a channel, according to some examples of the disclosure.

FIG. 5 illustrates a method for processing a task descriptor encoding data movement operation and executing the data movement operation, according to some examples of the disclosure.

FIG. 6A illustrates a task descriptor having one or more dynamic size fields, according to some examples of the disclosure.

FIG. 6B illustrates one or more runtime values, according to some examples of the disclosure.

FIG. 6C illustrates a patched task descriptor, according to some examples of the disclosure.

FIG. 7A illustrates a task descriptor having a dynamic dimension field, according to some examples of the disclosure.

FIG. 7B illustrates one or more runtime values, according to some examples of the disclosure.

FIG. 7C illustrates a patched task descriptor, according to some examples of the disclosure.

FIG. 8A illustrates a task descriptor having a dynamic address field, according to some examples of the disclosure.

FIG. 8B illustrates one or more runtime values, according to some examples of the disclosure.

FIG. 8C illustrates a patched task descriptor, according to some examples of the disclosure.

FIG. 9A illustrates a task descriptor having a dynamic skip field, according to some examples of the disclosure.

FIG. 9B illustrates one or more runtime values, according to some examples of the disclosure.

FIG. 9C illustrates a patched task descriptor, according to some examples of the disclosure.

FIG. 9D illustrates a further patched task descriptor, according to some examples of the disclosure.

FIG. 10 illustrates a method for address generation, according to some examples of the disclosure.

FIG. 11 is a flow diagram illustrating a method for operating a data movement engine, according to some examples of the disclosure.

FIG. 12 depicts a block diagram of an exemplary computing device, according to some examples of the disclosure.

### DETAILED DESCRIPTION

### Overview

Neural network inference often involves substantial data movement between memory resources and compute engines. In large models, such as language models or large language models, the amount and pattern of data movement can depend on runtime input parameters, including the sequence length of an input prompt. Conventional static compilation may encode data movement tasks for a worst-case input size, causing unnecessary transfers when the actual input is smaller. Alternatively, software may patch precompiled task descriptors at runtime, but this requires parsing and modifying many descriptors and can introduce significant latency and energy overhead.

The disclosed architecture addresses one or more of these limitations using a data movement engine that performs hardware-assisted runtime patching of task descriptors. A neural network accelerator includes one or more compute engines, a memory usable or accessible by the compute engines, and a data movement engine that moves data to and from the memory during execution of a neural network model. The data movement engine includes a link agent circuit and a channel circuit. The link agent circuit processes task descriptors before execution, while the channel circuit executes the resulting data movement operations.

In some examples, a task descriptor encodes a data movement operation using fields such as source address, destination address, transfer size, dimension size, stride, and link address. For dynamic operation, a descriptor field may store a pointer to a memory location. In some examples, the descriptor field stores the pointer in lieu of, or rather than directly storing a compile-time value. The memory location stores a runtime value, such as a value derived from the actual input sequence length or another runtime execution parameter. The link agent circuit uses the pointer to read the runtime value and generate a patched task descriptor that has one or more resolved execution parameters.

In some examples, an enable indicator, flag, code, or bit, in the task descriptor controls whether a field is interpreted as a pointer rather than as a compile-time value. This allows the descriptor format to support both static and dynamic fields without requiring a separate descriptor structure. When the enable indicator is active, the link agent circuit detects that the associated field stores a pointer, reads the runtime value from the indicated memory location, and patches an internal version of the descriptor. In some examples, the original descriptor stored in memory can remain unchanged, allowing the compiled task representation to be reused across different runtime input parameters.

In some examples, one or more runtime values may be stored in a parameter table in memory. Software, firmware, or another hardware component may populate the parameter table before or during inference based on model input parameters or intermediate runtime results. In some examples, multiple task descriptors may store pointers to the same memory location in the parameter table. Multiple task descriptors may reference the same runtime value, such that updating that value can change the resolved execution parameters of multiple corresponding data movement tasks. This allows a group of related tasks to be tuned together through a shared parameter table, rather than requiring software or hardware to separately patch each descriptor. As a result, the data movement graph can be adjusted in a coordinated manner while reducing descriptor-specific update overhead.

In some examples, the link agent circuit supports different forms of descriptor patching. For direct replacement, the link agent circuit replaces a descriptor field with the runtime value read from the memory location indicated by the pointer. This mode may be used for, e.g., transfer size fields and dimension size fields, such that a field that would otherwise encode a byte count or loop repetition count is resolved using a runtime value. For additive patching, the descriptor field stores an offset and the runtime value provides a base address. The link agent circuit computes a sum of the offset and the base address and uses the sum as the resolved value in the patched task descriptor, which may be useful for resolving source addresses, destination addresses, or link addresses.

Additive patching is one example of a computation that may be performed by the link agent circuit to generate a resolved execution parameter. In other examples, the link agent circuit may compute a resolved value by subtracting an offset from a runtime value, applying a scale factor to a runtime value, selecting one of multiple candidate values based on a runtime selector, masking or shifting a runtime value, combining multiple runtime values, clamping a runtime value to a permitted range, applying an alignment operation, or applying another hardware-resolvable transformation. Such computations may produce, for example, an aligned address, transfer size, dimension size, stride value, tile size, memory bank identifier, buffer identifier, priority value, task-control parameter, or a suitable parameter used by the data movement engine to execute a data movement operation.

More generally, a dynamic field in a task descriptor may identify or specify a runtime value that is used directly or as an input to a hardware computation that produces a resolved execution parameter. The resolved execution parameter may be generated using information encoded in the task descriptor, information retrieved from a runtime-accessible memory location, one or more additional runtime values, one or more hardware configuration values, or a combination thereof. Thus, the runtime patching mechanism is not limited to replacing a field with a fetched value or adding a fetched base address to an encoded offset. Rather, the mechanism can support any hardware-resolvable transformation in which descriptor information and/or runtime-accessible information is used to generate a patched task descriptor for execution by a data movement engine.

In some examples, dynamic transfer size patching allows a transfer size field to be resolved at runtime. A compiled descriptor may store a pointer in a field, e.g., a field that ordinarily encodes the number of bytes to transfer. The link agent reads the runtime transfer size and replaces the transfer size field in the patched descriptor. In some examples, if the runtime transfer size is zero, the channel circuit may skip the data phase of the data movement operation, providing a fine-grained way to suppress unnecessary movement without rewriting the descriptor in memory.

In some examples, dynamic dimensionality patching can be used to set multi-dimensional addressing patterns at runtime. A dimension size field may encode a repetition count of a loop in a multi-dimensional data movement pattern, or, when enabled for dynamic operation, may store a pointer to a runtime repetition count. The link agent reads the runtime value and replaces the dimension size field in the patched descriptor. Different dimensions may be patched independently, allowing the accelerator to adapt loop counts for selected dimensions while preserving other statically compiled parameters.

In some examples, dynamic address patching supports source, destination, or link address fields. A source or destination address field may store an offset, while a runtime value provides a base address value. The link agent adds the offset to the base address value and replaces the corresponding address field in the patched descriptor with the computed runtime address. A link address field may be patched in the same manner, allowing a linked list of task descriptors to be relocated in memory by updating a runtime base address value rather than modifying each descriptor.

In some examples, the architecture supports dynamic task skipping based on a runtime threshold. A task descriptor may include a task identifier, and the runtime value may be a threshold value. If the task identifier meets or exceeds the threshold, the data phase of the operation is skipped. The control phase, including synchronization operations such as barriers, semaphores, or suitable graph-control events, can still execute. This preserves the connectivity and ordering semantics of the compiled task graph while eliminating unnecessary data movement.

In some examples, the channel circuit executes the data movement operation according to the patched task descriptor produced by the link agent. Because patching is completed before the descriptor is supplied for execution, the channel can process the descriptor as a normal resolved task. This separation allows the patching function to be centralized in the link agent while keeping the data movement execution hardware focused on generating addresses and transferring data.

The approach is applicable to neural network accelerators, neural processing units, data movement acceleration engines, direct memory access engines, graphics processors, vision processors, digital signal processors, tensor accelerators, and other systems that execute compiled data movement tasks whose parameters depend on runtime conditions. Although sequence length in language-model inference is a useful example, the same architecture may be used for other runtime-dependent parameters, including prompt length, batch size, tensor shape, tensor rank, channel count, tile size, window size, stride pattern, padding amount, sparsity pattern, attention-mask shape, key-value cache length, activation buffer size, dynamically allocated source or destination buffer locations, linked-list relocation addresses, conditional graph regions, runtime-selected branches, and runtime-generated metadata. More generally, the technique may be used when a compiler can identify a data movement parameter that is not fixed until execution time and can encode a descriptor field as a pointer to a runtime value, allowing the link agent circuit to resolve the parameter in hardware before the channel circuit executes the corresponding data movement operation.

This technique improves runtime adaptability while reducing software overhead. It avoids executing worst-case data movement when smaller transfers are sufficient, reduces the need to parse and rewrite large numbers of descriptors, and allows multiple descriptors to be tuned through shared runtime values. By performing descriptor patching in hardware and preserving the stored descriptor representation, the architecture can improve latency, energy efficiency, memory bandwidth utilization, and implementation flexibility for dynamically shaped neural network workloads.

The link agent circuit and channel circuit architecture described herein is provided as one illustrative organization of hardware logic for performing runtime task descriptor patching and executing data movement operations. In other examples, the functions described with respect to the link agent circuit, the channel circuit, or both may be partitioned, combined, replicated, distributed, pipelined, or arranged across different hardware circuits, firmware-controlled hardware modules, processing stages, or execution resources. For example, descriptor fetching, dynamic field detection, runtime value retrieval, descriptor patching, address generation, task scheduling, synchronization handling, and data transfer execution may be performed by separate circuits, by a common circuit, or by partially overlapping logic. Accordingly, references to a link agent circuit and a channel circuit are not intended to require a particular physical boundary between descriptor-processing logic and data-movement execution logic, unless expressly stated.

The techniques described herein are not limited to a data movement engine having a separate link agent circuit and channel circuit, or to any particular descriptor-processing pipeline. The runtime patching mechanisms may be applied to other data movement engines having different hardware organizations, including engines in which descriptor fetching, descriptor decoding, runtime value retrieval, descriptor patching, address generation, task scheduling, synchronization handling, and data transfer execution are performed by different combinations of circuits or processing stages. For example, the same dynamic field-resolution techniques may be implemented in a direct memory access engine, a copy engine, a tensor data mover, a memory fabric controller, a gather/scatter engine, a streaming engine, or another hardware module that executes compiled data movement tasks. Thus, a data movement engine with a different architecture may still use descriptor fields that selectively store pointers to runtime values, resolve those runtime values in hardware, and execute data movement operations according to the resolved task information.

As used herein, “task descriptor” can refer to any data structure, command structure, instruction structure, descriptor, or encoded information stored in memory that identifies one or more parameters for a data movement operation to be performed by a data movement engine.

As used herein, “data movement operation” can refer to any operation that transfers, copies, reads, writes, relocates, gathers, scatters, streams, or moves data between one or more source memory locations and one or more destination memory locations.

As used herein, “data movement engine” can refer to a hardware circuit, hardware module, direct memory access engine, data movement accelerator, or a suitable execution resource that performs data transfers for a processor, neural network accelerator, neural processing unit, compute engine, or a suitable hardware system.

As used herein, “link agent circuit” can refer to hardware logic that fetches, reads, decodes, interprets, patches, updates, resolves, or processes a task descriptor before the task descriptor is executed by a channel circuit or a suitable data movement execution circuit.

As used herein, “channel circuit” can refer to hardware logic that executes a data movement operation according to a task descriptor, patched task descriptor, resolved task descriptor, command, or a suitable data movement configuration received from a link agent circuit or another front-end circuit.

As used herein, “patched task descriptor” can refer to a task descriptor, internal task representation, resolved task command, or a suitable descriptor information that has been updated, supplemented, overwritten, or modified using one or more runtime values. A patched task descriptor need not be written back to the memory location that stores the original task descriptor.

As used herein, “runtime value” can refer to a value that is determined, generated, selected, calculated, populated, or made available before or during execution of a neural network model, inference operation, data movement task, or a suitable workload. A runtime value can be based on an input parameter, an execution parameter, a model parameter, a memory allocation, metadata, or an intermediate result generated during execution.

As used herein, “input parameter” can refer to a parameter associated with a particular execution instance of a workload, including a neural network input, prompt, tensor, batch, sequence, graph, or model invocation. Examples of input parameters include one or more of: sequence length, prompt length, batch size, tensor shape, tensor rank, tile size, channel count, attention-mask size, and key-value cache length.

As used herein, “field” can refer to a bit, set of bits, register field, descriptor field, encoded value, parameter location, or portion of a task descriptor that stores or represents information used to perform a data movement operation.

As used herein, “pointer” can refer to any address, memory reference, offset, index, table entry reference, identifier, relative pointer, or value usable to locate a runtime value in a memory, table, buffer, register file, or storage structure. In some examples, a pointer may directly identify a memory location storing the runtime value. In some examples, a pointer may be a relative pointer, such as an offset, index, or displacement that is resolved relative to a base address, table base, segment base, descriptor base, job base, memory-region base, or another reference value to identify the memory location storing the runtime value. Thus, a descriptor field that stores a pointer need not store a complete absolute address and may instead store information that a link agent circuit uses with a base address or other reference information to locate the runtime value.

As used herein, “enable indicator” can refer to a bit, flag, field, control value, mode indicator, configuration value, or suitable encoded information indicating that a corresponding descriptor field is to be interpreted as storing a pointer, address, reference, offset, or suitable dynamic information instead of a compile-time value.

As used herein, “parameter table” can refer to a table, array, buffer, memory region, lookup table, pivot table, address patching table, mailbox, or suitable storage structure that stores one or more runtime values accessible to a link agent circuit or suitable hardware logic.

As used herein, “memory” can refer to a volatile or non-volatile storage resource, including internal memory, on-chip memory, cache memory, scratchpad memory, closely coupled memory, external memory, system memory, register memory, or a combination thereof.

As used herein, “internal memory” can refer to memory located on the same integrated circuit, accelerator, subsystem, tile, or hardware device as a data movement engine, neural processing unit, or compute engine. Internal memory can include closely coupled memory, scratchpad memory, cache memory, or suitable memory that is accessible with lower latency, lower energy, or higher bandwidth than an external memory.

As used herein, “dynamic field” can refer to a field of a task descriptor that is interpreted, based on an enable indicator or suitable control information, as storing a pointer to a runtime value rather than directly storing a compile-time execution value.

As used herein, “compile-time value” can refer to a value determined before runtime, including a value encoded by a compiler, driver, firmware, or software tool when generating a task descriptor, task list, graph representation, or application binary.

As used herein, “direct replacement” can refer to a patching operation in which a field of a task descriptor or an internal copy thereof is replaced with a runtime value read from a memory location identified by a pointer.

As used herein, “additive patching” can refer to a patching operation in which a resolved value is computed by adding, combining, or applying a runtime value to a value stored in a task descriptor field, such as adding a runtime base address to an offset stored in the descriptor field.

As used herein, “dynamic transfer size patching” can refer to resolving a transfer size, width, byte count, linear kernel size, or an amount of data to be transferred using a runtime value.

As used herein, “dynamic dimensionality patching” can refer to resolving a dimension size, repetition count, loop count, tensor dimension, or suitable multi-dimensional addressing parameter using a runtime value.

As used herein, “dynamic address patching” can refer to resolving a source address, destination address, link address, base address, effective address, or suitable address parameter using a runtime value.

As used herein, “link address” can refer to an address, pointer, offset, reference, or suitable information identifying another task descriptor, such as a next task descriptor in a list, linked list, chain, graph, or sequence of task descriptors.

As used herein, “dynamic task skip” can refer to determining, based on a runtime value, whether to omit, suppress, bypass, or refrain from performing a data phase of a data movement operation while still allowing at least a portion of a control phase of the data movement operation to execute.

As used herein, “data phase” can refer to a portion of a data movement operation in which data is read, written, transferred, copied, moved, or communicated between a source and a destination.

As used herein, “control phase” can refer to a portion of a data movement operation involving synchronization, dependency tracking, barrier updates, semaphore operations, interrupt generation, completion signaling, graph-control signaling, or suitable non-data-transfer operations.

As used herein, “task identifier” can refer to an identifier, index, sequence position, ordering value, task number, descriptor number, or suitable value that identifies a task descriptor or indicates a relative position of a data movement task within a sequence, group, graph, or linked list of tasks.

As used herein, “threshold value” can refer to any value used to determine whether a data phase of a data movement operation is executed or skipped, including a value compared with a task identifier, index, sequence position, or suitable descriptor-associated value.

As used herein, “multi-dimensional addressing pattern” can refer to an addressing pattern that defines data movement using two or more parameters, loops, dimensions, strides, repetition counts, widths, source-side parameters, destination-side parameters, or nested addressing relationships.

As used herein, “stride” can refer to an offset, increment, decrement, signed value, byte distance, address delta, or suitable value applied to generate a subsequent address in an addressing pattern.

As used herein, “runtime condition” can refer to any condition, parameter, input characteristic, execution state, memory allocation, model state, graph state, metadata value, or hardware-generated value that is known, determined, or resolved before or during execution rather than being fully fixed at compile time.

### Hardware Accelerator Architecture

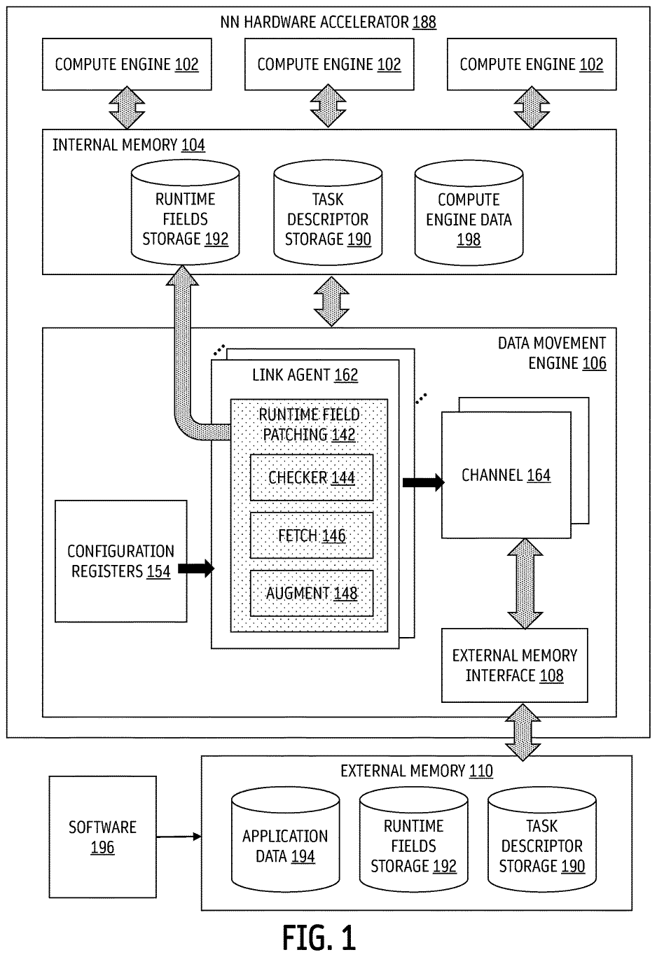

FIG. 1 illustrates NN hardware accelerator 188 having data movement engine 106 with runtime field patching 142 integrated therein, according to some examples of the disclosure. NN hardware accelerator 188 can include one or more compute engines 102, internal memory 104, and data movement engine 106. Compute engines 102 can execute operations of a neural network model using data stored in internal memory 104, data received from external memory 110, or both. Internal memory 104 can include one or more storage regions, buffers, caches, scratchpad memories, closely coupled memories, or suitable memory structures usable by compute engines 102 and data movement engine 106 during execution of the neural network model.

In some examples, internal memory 104 comprises one or more of runtime fields storage 192, task descriptor storage 190, and compute engine data 198. Runtime fields storage 192 can store one or more runtime values used to resolve dynamic fields of task descriptors. Task descriptor storage 190 can store one or more task descriptors encoding data movement operations. Compute engine data 198 can store input data, output data, weights, activations, intermediate results, key-value cache data, tensor data, or suitable data used or generated by compute engines 102. Although runtime fields storage 192 and task descriptor storage 190 are shown within internal memory 104, runtime fields and task descriptors may additionally or alternatively be stored in external memory 110, cached in internal memory 104, copied into internal memory 104 before execution, generated by hardware during execution, or distributed across multiple memory structures.

In some examples, external memory 110 comprises one or more of application data 194, runtime fields storage 192, and task descriptor storage 190. Application data 194 can include a compiled neural network application, model data, graph data, metadata, software-visible configuration data, or information associated with execution of a neural network model. For example, application data 194 can include a compiled execution graph, task graph, layer graph, operator graph, scheduling information, dependency information, synchronization information, kernel information, model weights, tensor descriptors, memory layout information, buffer allocation information, shape metadata, quantization parameters, tiling information, attention metadata, key-value cache metadata, or model-execution information. Application data 194 may also include information used by software 196, firmware, compute engines 102, data movement engine 106, or a combination thereof to identify task descriptors in task descriptor storage 190, populate runtime fields storage 192, submit jobs to data movement engine 106, or coordinate data movement operations with compute operations. Thus, application data 194 can include both data directly processed during neural network execution and control or metadata used to configure, schedule, or adapt execution of the neural network model. Runtime fields storage 192 in external memory 110 can store runtime values before such values are copied to internal memory 104 or can store runtime values accessed by data movement engine 106 through external memory interface 108. Task descriptor storage 190 in external memory 110 can store compiled task descriptors that are fetched directly by data movement engine 106 or staged into internal memory 104.

In some examples, software 196 can populate, update, or make available application data 194, runtime fields storage 192, task descriptor storage 190, or a combination thereof. For example, software 196 can load a compiled neural network application into external memory 110, including model data, graph metadata, and task descriptors generated by a compiler. Software 196 can also allocate memory regions for task descriptor storage 190 and runtime fields storage 192, copy task descriptors into those memory regions, initialize runtime fields storage 192 with default values, and provide data movement engine 106 with one or more addresses identifying where task descriptors or runtime values are stored.

In some examples, software 196 can further update runtime fields storage 192 based on information that is not known until execution of a neural network model. For example, software 196 can determine or receive an input sequence length, prompt length, batch size, tensor shape, buffer base address, key-value cache length, selected graph branch, or runtime parameter, and can write one or more corresponding runtime values into runtime fields storage 192. Because task descriptors in task descriptor storage 190 may include fields that point to those runtime values, software 196 does not need to rewrite each task descriptor that depends on the runtime parameter. Instead, software 196 can update the runtime value once, or update a small set of runtime values, and link agent 162 can resolve the corresponding descriptor fields when processing the task descriptors.

In some examples, software 196 can make application data 194, runtime fields storage 192, or task descriptor storage 190 available indirectly. For example, software 196 can provide pointers, handles, physical addresses, virtual addresses, table identifiers, job descriptors, or configuration values to firmware, driver logic, configuration registers 154, link agent 162, or another control component. Software 196 can also cause runtime values or task descriptors to be staged from external memory 110 into internal memory 104 before execution, cached in internal memory 104 during execution, or updated in response to a new inference request. Thus, software 196 can participate in preparing the compiled task information and runtime parameter information, while runtime field patching 142 resolves dynamic descriptor fields in hardware during task processing.

In some examples, data movement engine 106 can move data to and/or from internal memory 104 for execution of a neural network model by compute engines 102. In some examples, data movement engine 106 comprises configuration registers 154, link agent 162, channel 164, and external memory interface 108. In some examples, configuration registers 154 can store task start information, descriptor addresses, job submission information, mode information, or configuration state used to initiate or control data movement operations. External memory interface 108 can provide access between data movement engine 106 and external memory 110, including access to application data 194, runtime values in runtime fields storage 192, or task descriptors in task descriptor storage 190.

In some examples, link agent 162 can fetch a task descriptor from task descriptor storage 190 (from internal memory 104 or external memory 110), process the task descriptor, and generate a patched task descriptor based on one or more runtime values stored in runtime fields storage 192. In some examples, runtime field patching 142 in link agent 162 represents hardware logic, control logic, pipeline stages, or a combination thereof that resolves one or more dynamic fields of a task descriptor before execution by channel 164. For example, a field of a task descriptor may store a pointer to a memory location storing a runtime value, and in some cases, rather than directly storing a compile-time value. Runtime field patching 142 can use the pointer to retrieve the runtime value and generate a patched task descriptor in which the corresponding execution parameter is resolved.

In some examples, runtime field patching 142 can include checker 144, fetch 146, and augment 148. Checker 144 can detect whether a field of a task descriptor stores a pointer to a runtime value, such as by evaluating an enable indicator, flag, mode bit, field type, descriptor format, configuration value, or control information associated with the task descriptor. Fetch 146 can read a runtime value from a memory location indicated by the pointer, including from runtime fields storage 192 in internal memory 104 or external memory 110. Augment 148 can generate a patched task descriptor by replacing a field with the runtime value, computing a resolved value based on the runtime value and information encoded in the task descriptor, or updating an internal representation of the task descriptor for execution.

In some examples, runtime field patching 142 can support one or more forms of descriptor patching. For direct replacement, link agent 162 can replace a descriptor field with a runtime value read from runtime fields storage 192, such as when resolving a transfer size field, dimension size field, loop count field, or task parameter. For computed patching, link agent 162 can compute a resolved value based on a runtime value and descriptor-encoded information, such as by adding a runtime base address to an offset encoded in a source address field, destination address field, or link address field. Other hardware-resolvable transformations may also be used, including scaling, masking, shifting, selecting, clamping, aligning, or combining one or more runtime values to generate a resolved execution parameter.

In some examples, runtime fields storage 192 can operate as a parameter table shared by multiple task descriptors. Multiple task descriptors stored in task descriptor storage 190 may reference the same runtime value in runtime fields storage 192, such that updating that runtime value can change the resolved execution parameters of multiple corresponding data movement tasks. This allows a group of related tasks to be tuned together through shared runtime information, rather than requiring software 196 or data movement engine 106 to separately patch each stored descriptor. As a result, a data movement graph can be adjusted in a coordinated manner while reducing descriptor-specific update overhead.

In some examples, channel 164 can execute a data movement operation according to a patched task descriptor generated by link agent 162. In some examples, channel 164 receives resolved task information from link agent 162 and performs address generation, data reads, data writes, synchronization handling, completion signaling, or operations associated with the data movement operation. Because link agent 162 can resolve dynamic fields before channel 164 executes the task, channel 164 may process the patched task descriptor in the same manner as a task descriptor whose relevant fields were fixed before runtime (e.g., at compile time).

Architecture shown for data movement engine 106 is illustrative. Functions described with respect to link agent 162, runtime field patching 142, checker 144, fetch 146, augment 148, channel 164, configuration registers 154, or external memory interface 108 may be partitioned, combined, replicated, distributed, pipelined, or arranged across different hardware circuits, firmware-controlled hardware modules, processing stages, or execution resources. Accordingly, runtime field patching 142 may be implemented in data movement engines having different architectures, including engines in which descriptor fetching, dynamic field detection, runtime value retrieval, descriptor patching, address generation, task scheduling, synchronization handling, and data transfer execution are performed by different combinations of logic.

### Example Linked List of Data Movement Tasks

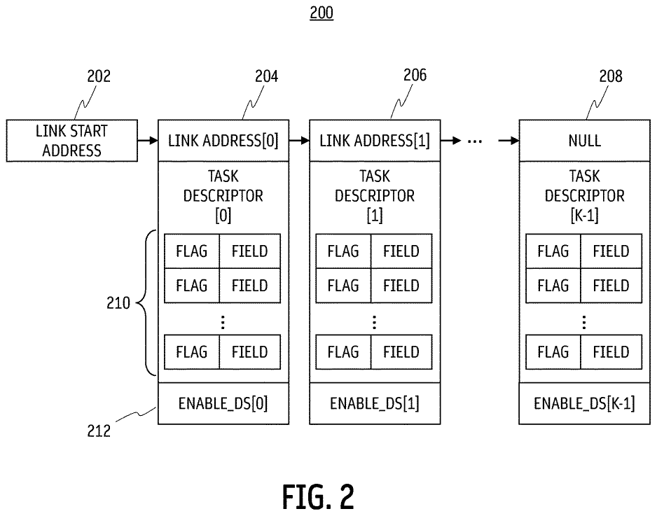

FIG. 2 illustrates linked list 200 of data movement tasks, according to some examples of the disclosure. In some examples, linked list 200 can include link start address 202 and a plurality of task descriptors, including task descriptor 204, task descriptor 206, and task descriptor 208. Link start address 202 can identify a first task descriptor in linked list 200. Each task descriptor can encode a corresponding data movement operation and can include a link address that identifies a next task descriptor to be processed. For example, task descriptor 204 can include link address[0] pointing to task descriptor 206, and task descriptor 206 can include link address[1] pointing to a subsequent task descriptor. Task descriptor 208 can include a null link value indicating an end of linked list 200.

In some examples, a task descriptor encapsulates all necessary information for the data movement engine to perform a specific data movement task, such as source and destination addresses, transfer size, and control parameters. In particular, the task descriptor includes configuration information to configure the data movement engine to carry out the data movement task. In some examples, a task descriptor encoding or describing a data movement task can include one or more fields or data, such as source and destination memory addresses (indicating where data should be read from and written to), transfer size (the amount of data to be moved), context identifier (specifies the execution context or application domain for the task), task identifier (uniquely identifies the task within a context, optionally assigned by software such as the compiler), control flags and options (e.g., settings for profiling, chaining, or special handling), and a pointer to the next task descriptor (e.g., to link multiple tasks into a linked list for sequential or pipelined execution).

In some examples, task descriptor 204, task descriptor 206, and task descriptor 208 can be stored in task descriptor storage 190 of FIG. 1, internal memory 104 of FIG. 1, external memory 110 of FIG. 1, or a combination thereof. In some examples, link agent 162 of FIG. 1 can receive link start address 202 from configuration registers 154 of FIG. 1, fetch task descriptor 204 using link start address 202, process task descriptor 204, and then use link address[0] to identify task descriptor 206. Link agent 162 can continue fetching and processing task descriptors until reaching task descriptor 208 having the null link value. In this manner, linked list 200 can provide a compiled sequence of data movement tasks for execution by data movement engine 106.

A task descriptor in linked list 200 can include one or more dynamic field entries 210. In some examples, dynamic field entries 210 can include respective flag and field pairs. A flag can represent an enable indicator indicating whether a corresponding field stores a compile-time value or stores a pointer to a memory location containing a runtime value. A field can represent a descriptor field that encodes, for example, a transfer size, dimension size, source address, destination address, link address, stride value, task-control parameter, or another execution parameter for a data movement operation. When a flag indicates that a field stores a pointer, link agent 162 can read a runtime value from the memory location indicated by the field and generate a patched task descriptor based on the runtime value.

In some examples, dynamic field entries 210 can allow one or more fields within a same task descriptor to be independently static or dynamic. For example, one field of task descriptor 204 may directly encode a compile-time value, while another field of task descriptor 204 may store a pointer to runtime fields storage 192 of FIG. 1. Similarly, task descriptor 204 and task descriptor 206 may include different combinations of static fields and dynamic fields, allowing each data movement task to be selectively adapted based on runtime conditions. This allows a compiler to generate linked list 200 with descriptor fields that are already wired to runtime values, while allowing link agent 162 to resolve those fields in hardware when corresponding task descriptors are processed.

In some examples, dynamic field entries 210 can correspond to a suitable task descriptor field whose resolved value may depend on a runtime value. For example, dynamic field entries 210 can include one or more of: a transfer size field, a width field, a source width field, a destination width field, a byte count field, a linear transfer size field, a linear kernel size field, a source dimension size field, a destination dimension size field, a loop count field, a repetition count field, a tensor dimension field, a tile dimension field, a source address field, a destination address field, a link address field, a base address field, an offset field, a source base address pointer field, a destination base address pointer field, a link base address pointer field, a stride field, a source stride field, a destination stride field, a signed stride field, an address-increment field, an address-decrement field, a padding field, a dilation field, a gather index field, a scatter index field, a memory bank field, a memory channel field, a buffer identifier field, a tile identifier field, a tensor identifier field, a data format field, a precision field, a compression-mode field, a decompression-mode field, a sparsity-mode field, a mask field, an attention-mask field, a key-value cache length field, a sequence-length-dependent field, a batch-size-dependent field, a task identifier field, a threshold field, a skip-control field, a branch-control field, a task-priority field, a synchronization field, a barrier field, a semaphore field, an interrupt-control field, a completion-signaling field, a dependency-count field, a producer-count field, a consumer-count field, a graph-control field, a next-task field, and a descriptor-relocation field.

In some examples, an entry of dynamic field entries 210 can include a field that stores a pointer to a runtime value in lieu of a compile-time value. The runtime value can be used directly as the resolved value of the field, such as for a transfer size field, a width field, a dimension size field, a loop count field, a repetition count field, a threshold field, or a task-control field. In some examples, the runtime value can be used as an input to a hardware computation that generates the resolved value, such as when a source address field, destination address field, or link address field stores an offset and the runtime value provides a base address. In some examples, the hardware computation can include addition, subtraction, scaling, shifting, masking, alignment, selection, clamping, combining multiple runtime values, or combining a runtime value with a value encoded in the task descriptor.

In some examples, dynamic field entries 210 can be grouped by the type of data movement parameter being resolved. Size-related dynamic fields can include one or more of: transfer size, width, source width, destination width, byte count, and linear kernel size fields. Dimensionality-related dynamic fields can include one or more of: source dimension size, destination dimension size, loop count, repetition count, tile dimension, tensor dimension, and nested-loop control fields. Address-related dynamic fields can include source address, destination address, link address, base address, offset, source base address pointer, destination base address pointer, link base address pointer, descriptor relocation, and next-task fields. Pattern-related dynamic fields can include one or more of: stride, source stride, destination stride, signed stride, address increment, address decrement, padding, dilation, gather index, scatter index, and mask fields. Control-related dynamic fields can include one or more of: task identifier, threshold, skip-control, branch-control, priority, synchronization, barrier, semaphore, interrupt-control, completion-signaling, dependency-count, producer-count, consumer-count, and graph-control fields.

In some examples, dynamic field entries 210 can be associated with corresponding enable indicators. For example, a transfer size enable indicator can indicate that a transfer size field stores a pointer to a runtime transfer size value; a dimension size enable indicator can indicate that a dimension size field stores a pointer to a runtime repetition count; a relative address enable indicator can indicate that an address field is resolved using a runtime base address value; and enable_DS 212 can indicate that dynamic skip processing is enabled for a corresponding task descriptor. The enable indicators may be encoded per field, per group of fields, per descriptor, in a descriptor header, in configuration registers 154, in sideband metadata, or in a combination thereof.

In some examples, an enable indicator can be implemented using one or more bits, flags, fields, codes, values, or encodings that indicate whether one or more descriptor fields are to be treated as dynamic fields. In some examples, enable indicators can be implemented as a bitmap, where each bit corresponds to a respective field, group of fields, dimension, address type, data movement parameter, or entry of dynamic field entries 210. For example, different bits of the bitmap may indicate whether a transfer size field, a source dimension size field, a destination dimension size field, a source address field, a destination address field, or a link address field stores a pointer to a runtime value.

In some examples, enable indicators can be implemented as a code rather than a one-bit-per-field bitmap. For example, a code may identify a dynamic patching mode, a descriptor format, a subset of fields to be patched, a type of runtime value to fetch, a computation to apply to a runtime value, or a combination thereof. A code may therefore allow multiple dynamic-field configurations to be represented using fewer bits than a bitmap or may allow a descriptor to select among predefined patching patterns. In some examples, enable indicators may include both a bitmap and one or more codes, such that the bitmap identifies which fields are dynamic and the code identifies how the corresponding runtime values are used to generate resolved execution parameters.

In some examples, multiple task descriptors in linked list 200 may reference the same runtime value. For example, respective fields of task descriptor 204 and task descriptor 206 may store the same pointer to a memory location in runtime fields storage 192. Updating that runtime value can change resolved execution parameters of multiple corresponding data movement tasks. This allows a group of related tasks in linked list 200 to be tuned together through shared runtime information, rather than requiring software 196 of FIG. 1 or data movement engine 106 to separately patch each stored task descriptor. As a result, a data movement graph represented by linked list 200 can be adjusted in a coordinated manner while reducing descriptor-specific update overhead.

One or more of task descriptor 204, task descriptor 206, and task descriptor 208 can include enable_DS 212. Enable_DS 212 can represent an enable indicator for dynamic skip processing of a corresponding data movement task. In some examples, enable_DS 212 can indicate whether link agent 162 should evaluate dynamic skip information for the corresponding task descriptor, such as a task identifier and a pointer to a runtime threshold value. When enable_DS 212 indicates that dynamic skip is enabled, link agent 162 can obtain the runtime threshold value and determine whether a data phase of the corresponding data movement operation is to be executed or skipped based on a comparison between the task identifier and the runtime threshold value. In some examples, skipping the data phase does not skip a control phase of the data movement operation, such that synchronization operations, barrier updates, semaphore operations, interrupt generation, completion signaling, or graph-control signaling associated with the task descriptor can still be performed. This allows linked list 200 to preserve task ordering and graph connectivity while reducing data movement for tasks that are not needed for a particular runtime execution.

In some examples, link address fields in linked list 200 can also be dynamically patched. For example, link address[0] or link address[1] may store an offset, and a runtime value may provide a base address value. Link agent 162 can compute a runtime link address value by adding the offset to the base address value and can use the runtime link address value to identify a next task descriptor in linked list 200. Such dynamic link address patching can allow a compiled list of task descriptors to be relocated in memory by updating a runtime base address value, rather than modifying each link address stored in each task descriptor.

Although linked list 200 is shown as a linear sequence from task descriptor 204 to task descriptor 206 and ending at task descriptor 208, linked list 200 is illustrative. Task descriptors may be arranged as a list, chain, queue, table, graph, tree, ring, schedule, command buffer, or another descriptor organization usable by data movement engine 106. Similarly, dynamic field entries 210 are shown as flag and field pairs for clarity, but enable indicators and fields may be encoded using contiguous bits, non-contiguous bits, packed fields, descriptor headers, sideband metadata, configuration registers, or a combination thereof. Thus, runtime field patching 142 of FIG. 1 can be used with different task descriptor layouts and task sequencing structures.

### Lifecycle of a Data Movement Task or Operation

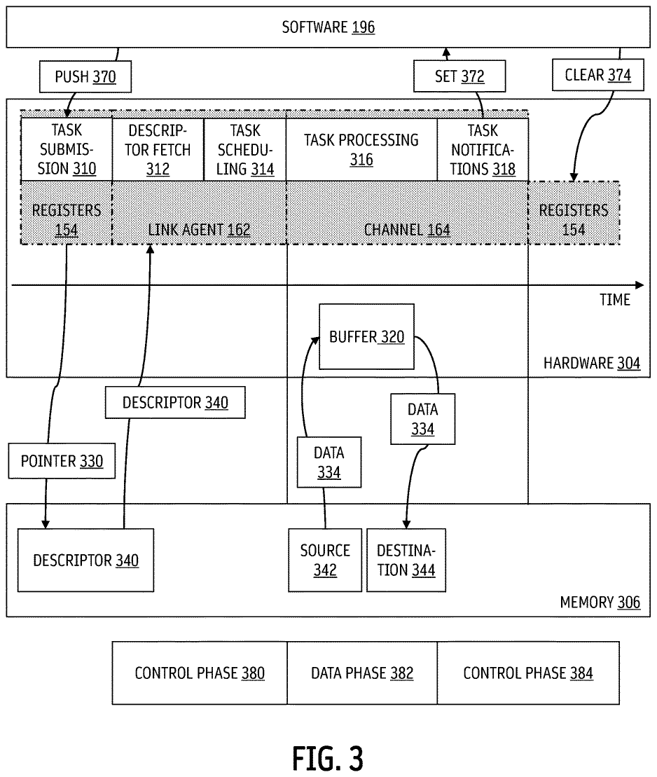

FIG. 3 illustrates a lifecycle of a data movement task through a data movement engine, according to some examples of the disclosure. The computing environment as illustrated in FIG. 3 can include software 196, hardware 304, and memory 306. Software 196 can represent an application, driver, runtime, firmware interface, operating system component, compiler-generated control flow, or a combination thereof. Hardware 304 can represent data movement engine 106 of NN hardware accelerator 188, or a portion thereof, including registers 154, link agent 162, and channel 164. Memory 306 can represent one or more levels of memory accessible to hardware 304, such as internal memory 104, external memory 110, cache memory, scratchpad memory, closely coupled memory, system memory, or a combination thereof.

The lifecycle can begin with task submission phase 310. During task submission phase 310, software 196 can issue push operation 370 to submit a data movement task to hardware 304. Push operation 370 can provide pointer 330 to registers 154. Pointer 330 can identify a memory location in memory 306 at which descriptor 340 is stored. Descriptor 340 can be a task descriptor encoding a data movement operation, including one or more parameters used to move data from source 342 to destination 344. In some examples, pointer 330 can be an absolute address, a relative pointer, an index, a handle, a table entry reference, or a value resolved relative to a base address to identify descriptor 340.

After task submission phase 310, hardware 304 can perform descriptor fetch phase 312. During descriptor fetch phase 312, link agent 162 can obtain pointer 330 from registers 154 and fetch descriptor 340 from memory 306. Descriptor 340 can include fields that directly encode execution parameters and fields that store pointers to runtime values. Thus, descriptor fetch phase 312 can provide link agent 162 with the task descriptor information used to determine whether any descriptor fields should be resolved using runtime field patching 142 of FIG. 1.

During descriptor fetch phase 312, link agent 162 may also perform dynamic field detection and runtime value retrieval. For example, link agent 162 can detect an enable indicator in descriptor 340 indicating that a field of descriptor 340 stores a pointer to a memory location storing a runtime value. Link agent 162 can then read the runtime value from memory 306 and generate a patched task descriptor based on the runtime value. The patched task descriptor can be generated by replacing a field of descriptor 340 with the runtime value, by computing a resolved value using the runtime value and information encoded in descriptor 340, or by applying another hardware-resolvable transformation. In some examples, descriptor 340 stored in memory 306 remains unchanged while link agent 162 patches an internal representation of descriptor 340.

After descriptor fetch phase 312, hardware 304 can perform task scheduling phase 314. During task scheduling phase 314, link agent 162 can prepare the data movement task for execution and dispatch the task to channel 164. Preparing the task can include checking task dependencies, resolving link addresses, ordering the task relative to other tasks, generating control information for channel 164, determining, signaling, or indicating whether a data phase should be skipped, or providing a patched task descriptor to channel 164. In some examples, link agent 162 can dispatch resolved task information to channel 164 such that channel 164 need not determine whether a field of descriptor 340 was patched at runtime.

After task scheduling phase 314, hardware 304 can perform task processing phase 316. During task processing phase 316, channel 164 can execute the data movement operation according to descriptor 340, the patched task descriptor, or resolved task information generated by link agent 162. Channel 164 can use buffer 320 to move data 334 from source 342 to destination 344. For example, channel 164 can read data 334 from source 342 into buffer 320 and write data 334 from buffer 320 to destination 344. Source 342 and destination 344 can be locations in memory 306, locations in different memory levels, locations associated with compute engines 102, or locations associated with external memory interface 108.

After task processing phase 316, hardware 304 can perform task notifications phase 318. During task notifications phase 318, channel 164, registers 154, or another portion of hardware 304 can communicate status information to software 196. For example, hardware 304 can issue set operation 372 to software 196, update registers 154 to indicate completion, signal an interrupt, update a completion flag, increment a counter, release a synchronization object, or indicate that descriptor 340 has been processed. Software 196 can then issue clear operation 374 to clear, reset, acknowledge, or update registers 154. In this manner, software 196 and hardware 304 can coordinate submission, execution, and completion of data movement tasks while allowing link agent 162 to resolve runtime-dependent task descriptor fields in hardware.

In some examples, task processing phase 316 can correspond to data phase 382. Data phase 382 can include reading data 334 from source 342, buffering data 334 in buffer 320, writing data 334 to destination 344, generating source addresses, generating destination addresses, applying strides, applying dimension counts, or performing transfers according to a transfer size resolved for the task. In some examples, channel 164 can execute a multi-dimensional data movement operation in which source-side addressing and destination-side addressing are independently defined, while total bytes read and total bytes written remain consistent for the transfer.

In some examples, the lifecycle can include control phase 380 before data phase 382 and/or control phase 384 after data phase 382. Control phase 380 and control phase 384 can include non-data-transfer operations associated with task execution, such as dependency checking, synchronization, barrier updates, semaphore operations, interrupt handling, completion signaling, task ordering, or graph-control signaling. In some examples involving dynamic skip, link agent 162 or channel 164 can determine that data phase 382 should be skipped based on a runtime threshold value and a task identifier of descriptor 340, while control phase 380, control phase 384, or both are still executed. Preserving one or more control phases while skipping data phase 382 can maintain graph connectivity and synchronization semantics even when data movement is reduced for a particular runtime execution.

### Hardware Implementation of a Data Movement Engine

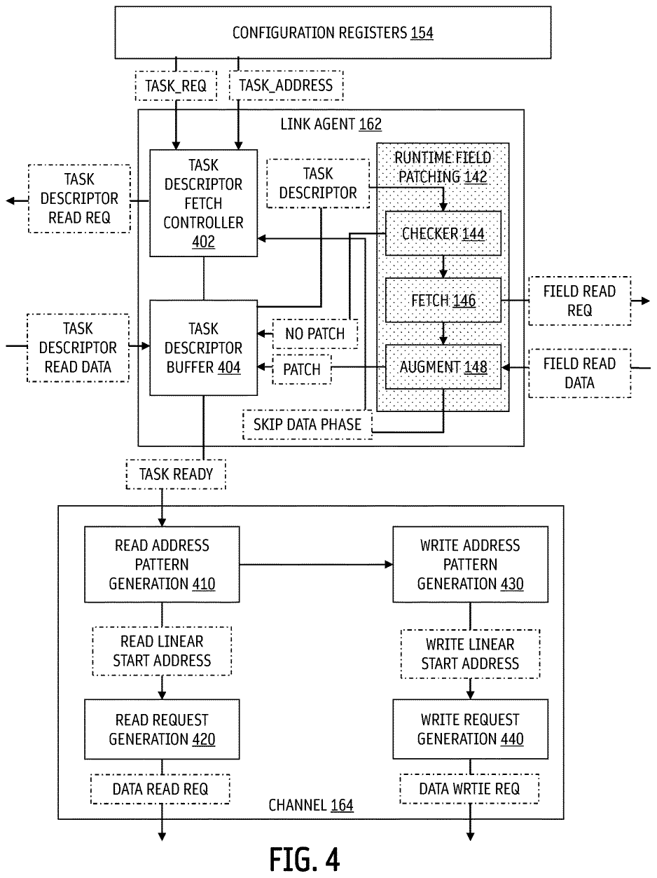

FIG. 4 illustrates link agent 162 and channel 164, according to some examples of the disclosure. Link agent 162 can process a task descriptor before the corresponding data movement operation is executed by channel 164. Link agent 162 can include one or more of: task descriptor fetch controller 402, task descriptor buffer 404, and runtime field patching 142. Configuration registers 154 can provide task request information and task address information to link agent 162. For example, configuration registers 154 can provide TASK_REQ to indicate that a task descriptor is to be processed and TASK_ADDRESS to identify a memory location storing the task descriptor.

In some examples, task descriptor fetch controller 402 can receive TASK_REQ and TASK_ADDRESS from configuration registers 154. Based on TASK_REQ and TASK_ADDRESS, task descriptor fetch controller 402 can generate a task descriptor read request to fetch a task descriptor from memory. Task descriptor fetch controller 402 can receive task descriptor read data in response to the task descriptor read request and can provide the task descriptor read data to task descriptor buffer 404. In some examples, task descriptor fetch controller 402 can fetch a task descriptor from task descriptor storage 190 in internal memory 104, external memory 110, memory 306, or a combination thereof.

In some examples, task descriptor buffer 404 can store the fetched task descriptor while link agent 162 determines whether the task descriptor is ready to be provided to channel 164. Task descriptor buffer 404 can store descriptor bits, decoded descriptor fields, intermediate descriptor information, patched descriptor information, or a combination thereof. In some examples, task descriptor buffer 404 can provide the task descriptor to runtime field patching 142 so that runtime field patching 142 can determine whether one or more fields of the task descriptor are dynamic fields. In some examples, task descriptor buffer 404 can store an internal copy of the task descriptor, and runtime field patching 142 can update the internal copy without modifying the task descriptor stored in memory.

In some examples, runtime field patching 142 can include one or more of checker 144, fetch 146, and augment 148. Checker 144 can examine the task descriptor, one or more enable indicators, one or more flags, one or more codes, a bitmap, descriptor type information, configuration state, or a combination thereof to determine whether a field of the task descriptor stores a pointer to a runtime value. For example, checker 144 can determine whether a transfer size field, a dimension size field, a source address field, a destination address field, a link address field, a threshold field, or a task-control field is to be resolved based on a runtime value rather than being treated as a compile-time value. If checker 144 determines that no field is to be patched, runtime field patching 142 (e.g., checker 144) can generate a no patch indication and task descriptor buffer 404 can provide the task descriptor as a ready task.

In some examples, if checker 144 determines that at least one field of the task descriptor is to be patched, fetch 146 can generate a field read request to obtain a runtime value from a memory location indicated by a pointer stored in the task descriptor. The pointer can be an absolute address, a relative pointer, an offset, an index, a table entry reference, or a value resolved relative to a base address. Fetch 146 can receive field read data in response to the field read request. The field read data can include one or more runtime values, such as a runtime transfer size, a runtime dimension size, a runtime threshold value, a runtime base address value, a runtime stride value, or a runtime task-control value.

In some examples, augment 148 can generate patched descriptor information based on field read data received by fetch 146. For direct replacement, augment 148 can replace a field of the task descriptor with a runtime value read from the memory location indicated by the pointer. For computed patching, augment 148 can compute a resolved value using the runtime value and information encoded in the task descriptor. For example, augment 148 can add a runtime base address value to an offset encoded in a source address field, destination address field, or link address field. In further examples, augment 148 can apply one or more of scaling, shifting, masking, selection, clamping, alignment, or a combination of multiple runtime values to produce a resolved execution parameter.

In some examples, runtime field patching 142 can provide a patch indication to task descriptor buffer 404 when one or more fields of the task descriptor have been resolved. Task descriptor buffer 404 can then store the patched task descriptor, store resolved task information derived from the patched task descriptor, or provide the patched task descriptor to channel 164. In some examples, the patch indication can identify which fields were patched, whether the task descriptor has been fully resolved, whether an additional field read request is needed, or whether the task descriptor can be marked as task ready. In this manner, link agent 162 can generate a patched task descriptor based on runtime values before channel 164 executes the data movement operation.

Runtime field patching 142 can also generate a skip data phase indication. For example, the task descriptor can include a task identifier and an enable indicator for dynamic skip processing, and a runtime value fetched by fetch 146 can include a threshold value. Checker 144, augment 148, or another portion of runtime field patching 142 can compare the task identifier with the threshold value and determine whether a data phase of the data movement operation should be skipped. When the comparison indicates that the data phase is to be skipped, runtime field patching 142 can provide the skip data phase indication to task descriptor buffer 404, task descriptor fetch controller 402, channel 164, or a combination thereof. Task descriptor buffer 404 can store the skip data phase indication with the corresponding task descriptor, mark the corresponding task descriptor as a task that does not require data transfer, suppress or modify data-phase fields in an internal task representation, or provide task-ready information indicating that the corresponding task descriptor is ready for control-phase processing. Task descriptor fetch controller 402 can use the skip data phase indication to avoid issuing additional memory reads associated with data-phase patching, proceed to a next task descriptor, or coordinate generation of task-ready signaling for channel 164. Channel 164 can skip data transfer activity associated with the task while still allowing one or more control-phase operations to be performed. Such control-phase operations can include one or more of synchronization, barrier update, semaphore operation, interrupt generation, completion signaling, and graph-control signaling.

In some examples, when the task descriptor is ready, task descriptor buffer 404 can assert TASK READY to channel 164. TASK READY can indicate that the task descriptor has been fetched and that dynamic fields, if any, have been resolved. Channel 164 can receive the patched task descriptor, the unpatched task descriptor when no patch is needed, resolved task information, the skip data phase indication, or a combination thereof. Because link agent 162 can complete runtime field patching before TASK READY is provided to channel 164, channel 164 can execute the data movement operation using resolved execution parameters without needing to distinguish whether those parameters were originally compile-time values or were patched using runtime values.

In some examples, channel 164 can include a read-side data movement path and a write-side data movement path. The read-side data movement path can include read address pattern generation 410 and read request generation 420. Read address pattern generation 410 can generate a read linear start address based on resolved source-side descriptor parameters, such as a source address, source width, source dimension size, source stride, or a combination thereof. Read request generation 420 can generate DATA READ REQ based on the read linear start address and a transfer size resolved for the task. DATA READ REQ can cause data to be read from a source memory location for the data movement operation. The write-side data movement path can include write address pattern generation 430 and write request generation 440. Write address pattern generation 430 can generate a write linear start address based on resolved destination-side descriptor parameters, such as a destination address, destination width, destination dimension size, destination stride, or a combination thereof. Write request generation 440 can generate DATA WRITE REQ based on the write linear start address and a transfer size resolved for the task. DATA WRITE REQ can cause data to be written to a destination memory location for the data movement operation.

Read address pattern generation 410 and write address pattern generation 430 can operate independently to support data movement operations in which source-side addressing and destination-side addressing follow different patterns. For example, channel 164 can read data using one multi-dimensional addressing pattern and write the data using another multi-dimensional addressing pattern, provided that the amount of data read and the amount of data written are consistent for the operation. An address pattern may be generated based on one or more resolved execution parameters produced by runtime field patching 142. For example, a source address, destination address, transfer size, dimension size, repetition count, stride value, base address, offset, tile size, or mask value used by read address pattern generation 410 or write address pattern generation 430 may be determined from a runtime value fetched by link agent 162. Thus, an address pattern generated by channel 164 need not be fixed entirely at compile time, and may instead reflect runtime information such as input sequence length, tensor shape, batch size, memory allocation, selected graph branch, or a combination thereof. Runtime field patching 142 can therefore resolve source-side parameters, destination-side parameters, or both before channel 164 performs address generation and request generation, allowing channel 164 to execute a data movement operation whose address pattern is adapted to runtime execution conditions.

The organization of link agent 162 and channel 164 is illustrative. Functions described with respect to task descriptor fetch controller 402, task descriptor buffer 404, runtime field patching 142, checker 144, fetch 146, augment 148, read address pattern generation 410, read request generation 420, write address pattern generation 430, and write request generation 440 may be partitioned, combined, replicated, distributed, pipelined, or arranged across different circuits or processing stages. For example, field detection, runtime value retrieval, descriptor patching, dynamic skip evaluation, address generation, and request generation may be performed by separate circuits, by a common circuit, or by partially overlapping hardware logic. Accordingly, data movement engines having different internal architectures can still use descriptor fields that selectively store pointers to runtime values, resolve those runtime values in hardware, and execute data movement operations according to the resolved task information.

### Runtime Task Descriptor Patching Flow

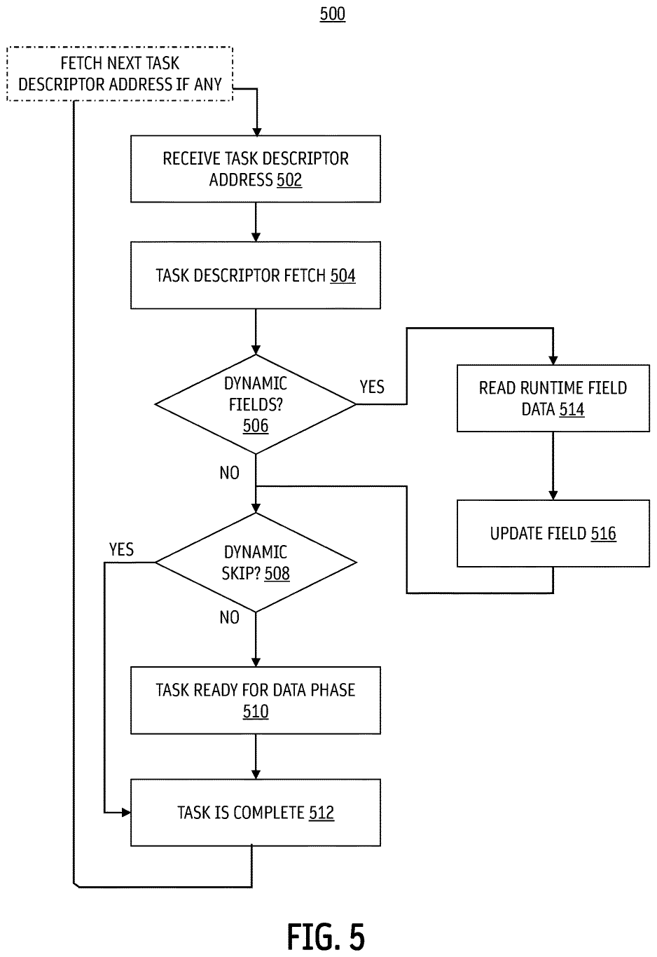

FIG. 5 illustrates method 500 for processing a task descriptor encoding a data movement operation and executing the data movement operation, according to some examples of the disclosure. Method 500 can be performed by data movement engine 106 of FIG. 1, link agent 162 of FIG. 4, channel 164 of FIG. 4, or a combination thereof. Method 500 can be used to fetch a task descriptor, determine whether the task descriptor includes one or more dynamic fields, resolve the one or more dynamic fields using runtime values, determine whether dynamic skip applies, and complete or execute the corresponding data movement task.

In 502, link agent 162 can receive a task descriptor address. Performing 502 can include receiving TASK_ADDRESS from configuration registers 154 of FIG. 4, receiving a link start address identifying a first task descriptor, or receiving a next task descriptor address from a link address of a previously processed task descriptor. In some examples, the task descriptor address can be an absolute address, a relative pointer, an index, a table entry reference, or a value resolved relative to a base address. As shown by the dashed operation, link agent 162 can fetch a next task descriptor address, if any, after task completion in 512 and can return to 502 to process a next task descriptor in a linked list or another task sequence.

In 504, task descriptor fetch controller 402 can fetch the task descriptor using the task descriptor address received in 502. Performing 504 can include one or more of issuing a task descriptor read request, receiving task descriptor read data, and storing the task descriptor read data in task descriptor buffer 404. In some examples, the fetched task descriptor can encode one or more fields for a data movement operation, such as one or more of a source address, a destination address, a transfer size, a dimension size, a stride, and a link address. The task descriptor can also include one or more enable indicators indicating whether corresponding fields are dynamic fields.

In 506, runtime field patching 142 can determine whether the task descriptor includes one or more dynamic fields. Performing 506 can include checker 144 examining one or more enable indicators, flags, bitmaps, codes, descriptor fields, descriptor type information, configuration state, or a combination thereof to determine whether a field stores a pointer to a runtime value. In some examples, a field can store the pointer in lieu of a compile-time value. If no dynamic field is detected, method 500 can proceed toward dynamic skip determination in 508. If one or more dynamic fields are detected, method 500 can proceed to read runtime field data in 514.

In 514, fetch 146 can read runtime field data. Performing 514 can include issuing a field read request to a memory location indicated by a pointer stored in the task descriptor and receiving field read data from the memory location. In some examples, the pointer can directly identify the memory location or can be a relative pointer resolved using a base address. The field read data can include one or more runtime values used to resolve one or more corresponding dynamic fields, such as one or more of a runtime transfer size, a runtime dimension size, a runtime base address, a runtime threshold value, and a runtime task-control value.

In 516, augment 148 can update a field of the task descriptor based on the runtime field data read in 514. Performing 516 can include replacing a field of the task descriptor with a runtime value, computing a resolved value using the runtime value and information encoded in the task descriptor, or applying a hardware-resolvable transformation to generate a patched task descriptor. In some examples, augment 148 can replace a transfer size field or a dimension size field with the runtime value. In some examples, augment 148 can compute a source address, destination address, or link address by adding a runtime base address value to an offset encoded in the task descriptor. After 516, method 500 can return to 506 to determine whether another dynamic field remains to be resolved before the task descriptor is provided for execution.

In 508, runtime field patching 142 can determine whether dynamic skip applies to the task descriptor. Performing 508 can include evaluating an enable indicator for dynamic skip processing, comparing a task identifier encoded in the task descriptor with a runtime threshold value, and determining whether a data phase of the data movement operation should be skipped. In some examples, the runtime threshold value can be read in 514 and used in 508. If dynamic skip does not apply, method 500 can proceed to 510. If dynamic skip applies, method 500 can bypass 510 and proceed to 512, such that the data phase is skipped while one or more control-phase operations associated with the task can still be performed.

In 510, channel 164 can receive an indication that the task is ready for a data phase. Performing 510 can include task descriptor buffer 404 asserting TASK READY to channel 164 after the task descriptor has been fetched and dynamic fields, if any, have been resolved. In some examples, channel 164 can execute the data movement operation using the task descriptor, the patched task descriptor, or resolved task information generated by link agent 162. Executing the data phase can include generating read address patterns using read address pattern generation 410, generating read requests using read request generation 420, generating write address patterns using write address pattern generation 430, generating write requests using write request generation 440, or transferring data between a source and a destination.

In 512, data movement engine 106 can determine that the task is complete. Performing 512 can include one or more of completing the data phase when 510 is performed, skipping the data phase when dynamic skip applies in 508, and performing any corresponding control-phase operations. In some examples, completing the task can include one or more of updating a completion state, generating a notification, updating a synchronization object, processing a link address, and making a next task descriptor address available. After 512, method 500 can fetch the next task descriptor address, if any, and return to 502 to process another task descriptor.

### Dynamic Transfer Size Patching

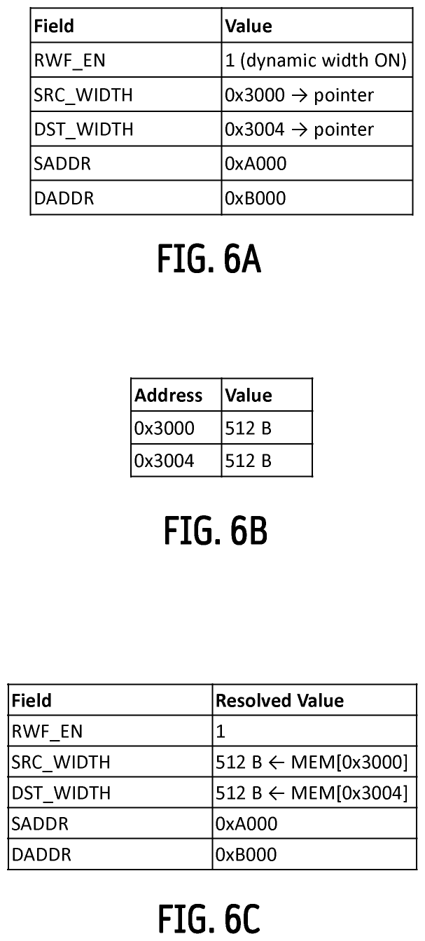

FIGS. 6A-6C illustrate an example of dynamic transfer size patching, according to some examples of the disclosure. In the example of FIGS. 6A-6C, a task descriptor includes one or more transfer size fields that store pointers to runtime values rather than compile-time transfer size values. Link agent 162 can detect that the one or more transfer size fields are dynamic, read the runtime values from memory locations identified by the pointers, and generate a patched task descriptor in which the transfer size fields are replaced with resolved transfer size values. Channel 164 can then execute the corresponding data movement operation according to the patched task descriptor.

FIG. 6A illustrates an example task descriptor having one or more dynamic size fields, according to some examples of the disclosure. The task descriptor includes RWF_EN, SRC_WIDTH, DST_WIDTH, SADDR, and DADDR. RWF_EN has a value of 1, indicating that dynamic width patching is enabled. SRC_WIDTH has a value of 0x3000 and DST_WIDTH has a value of 0x3004. Because RWF_EN indicates that dynamic width patching is enabled, SRC_WIDTH and DST_WIDTH can be interpreted as pointers to runtime width values rather than as transfer size values. SADDR has a value of 0xA000 and DADDR has a value of 0xB000, which can identify source and destination addresses for the data movement operation.

FIG. 6B illustrates one or more runtime values, according to some examples of the disclosure. In FIG. 6B, a runtime value of 512 B is stored at address 0x3000, and a runtime value of 512 B is stored at address 0x3004. These runtime values can be stored in runtime fields storage 192 of FIG. 1, a parameter table, internal memory 104, external memory 110, memory 306, or a combination thereof. In some examples, software 196, firmware, compute engines 102, data movement engine 106, or another hardware component can populate the runtime values before link agent 162 processes the task descriptor. In some examples, the runtime values can be based on one or more of an input sequence length, a prompt length, a batch size, a tensor shape, and a selected graph branch.

FIG. 6C illustrates a patched task descriptor, according to some examples of the disclosure. Link agent 162 can generate the patched task descriptor by replacing SRC_WIDTH with the runtime value read from MEM[0x3000] and replacing DST_WIDTH with the runtime value read from MEM[0x3004]. In the illustrated example, SRC_WIDTH is resolved to 512 B and DST_WIDTH is resolved to 512 B. This operation can be represented by the following pseudocode:

If TASK.DYN_WIDTH == 1 → RUNTIME.WIDTH =
MEM[TASK.WIDTH]

In this pseudocode, TASK.DYN_WIDTH can correspond to RWF_EN, TASK.WIDTH can correspond to SRC_WIDTH or DST_WIDTH before patching, and RUNTIME.WIDTH can correspond to the resolved width value used by channel 164 to execute the data movement operation. Thus, when RWF_EN is set, a width field that would otherwise encode a number of bytes to transfer instead stores a pointer to a memory location containing the runtime width value. RWF_EN remains set to 1, and SADDR and DADDR remain 0xA000 and 0xB000, respectively. The patched task descriptor therefore encodes a data movement operation in which 512 bytes are read from the source-side address pattern and 512 bytes are written to the destination-side address pattern.

Although FIGS. 6A-6C show SRC_WIDTH and DST_WIDTH being resolved to the same runtime value, source-side transfer size and destination-side transfer size may be resolved independently. For example, SRC_WIDTH and DST_WIDTH may point to different memory locations storing different runtime values, may point to the same memory location storing a shared runtime value, or may include one dynamic width field and one static width field. When multiple task descriptors point to the same runtime width value, updating that runtime width value can change the resolved transfer size for multiple corresponding data movement tasks. This allows a group of related data movement tasks to be tuned together through shared runtime information, rather than requiring software 196 or data movement engine 106 to separately patch each stored task descriptor.

Dynamic transfer size patching can be used for any transfer size parameter whose value is not fixed until runtime. For example, a dynamic transfer size field may correspond to one or more of a source width, a destination width, a byte count, a line length, a tile width, a tensor slice size, a row size, and a linear kernel size. The runtime value used to patch the transfer size field may be derived from one or more of a sequence length, a batch size, a tensor dimension, a tile configuration, a memory layout, and runtime-generated metadata. Thus, the same compiled task descriptor can be adapted to different execution instances by updating the runtime value referenced by the transfer size field.

In some examples, a runtime width value of zero can cause channel 164 to skip a data phase of the data movement operation. For example, if SRC_WIDTH, DST_WIDTH, or both are resolved to zero, channel 164 can determine that no data transfer is required for the corresponding task. In such examples, link agent 162 or channel 164 may still allow one or more control-phase operations associated with the task descriptor to be performed, such as one or more of synchronization, barrier update, semaphore operation, interrupt generation, completion signaling, and graph-control signaling. This provides a task-level mechanism for reducing data movement while preserving ordering and synchronization semantics of a compiled task graph.

The specific field names and values shown in FIGS. 6A-6C are illustrative. RWF_EN can be implemented as one or more of a flag, a bit in a bitmap, a descriptor field, a code, and a configuration value indicating that one or more transfer size fields are dynamic. SRC_WIDTH and DST_WIDTH can be replaced by any descriptor fields that encode transfer size information for a read side, a write side, or both. Similarly, the addresses 0x3000 and 0x3004 and the runtime values of 512 B are examples used to illustrate direct replacement patching. In other examples, link agent 162 can resolve transfer size fields using different pointer values, different runtime values, relative pointers, shared parameter table entries, or hardware computations that use runtime values to generate resolved transfer size values.

### Dynamic Dimensionality Patching

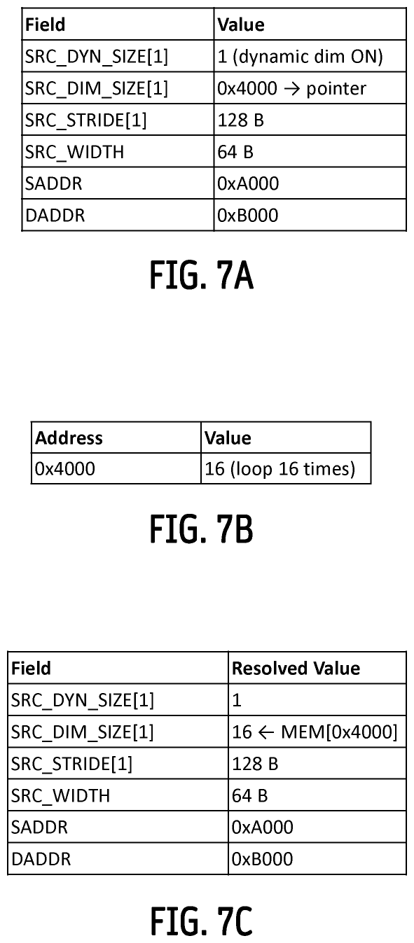

FIGS. 7A-7C illustrate an example of dynamic dimensionality patching, according to some examples of the disclosure. In the example of FIGS. 7A-7C, a task descriptor includes a dimension size field that stores a pointer to a runtime value rather than a compile-time loop count. Link agent 162 can detect that the dimension size field is dynamic, read the runtime value from a memory location identified by the pointer, and generate a patched task descriptor in which the dimension size field is replaced with a resolved dimension size value. Channel 164 can then execute the corresponding data movement operation according to the patched task descriptor.

FIG. 7A illustrates an example task descriptor having a dynamic dimension field, according to some examples of the disclosure. The task descriptor includes SRC_DYN_SIZE[1], SRC_DIM_SIZE[1], SRC_STRIDE[1], SRC_WIDTH, SADDR, and DADDR. SRC_DYN_SIZE[1] has a value of 1, indicating that dynamic dimension size patching is enabled for dimension [1] on the source side. SRC_DIM_SIZE[1] has a value of 0x4000. Because SRC_DYN_SIZE[1] indicates that dynamic dimension size patching is enabled, SRC_DIM_SIZE[1] can be interpreted as a pointer to a runtime dimension size value rather than as a compile-time repetition count. SRC_STRIDE[1] has a value of 128 B, SRC_WIDTH has a value of 64 B, SADDR has a value of 0xA000, and DADDR has a value of 0xB000.

FIG. 7B illustrates one or more runtime values, according to some examples of the disclosure. In FIG. 7B, a runtime value of 16 is stored at address 0x4000. The runtime value can be used to patch any dimension size field that stores a pointer to address 0x4000. In the example of FIG. 7A, SRC_DIM_SIZE[1] stores a pointer to 0x4000, and therefore the runtime value of 16 is used to resolve the source-side dimension size field indexed by [1]. In other examples, the same runtime value may be used to resolve a dimension size field corresponding to a different index, or multiple dimension size fields may store pointers to the same runtime value. The runtime value can be stored in runtime fields storage 192 of FIG. 1, a parameter table, internal memory 104, external memory 110, memory 306, or a combination thereof. In some examples, software 196, firmware, compute engines 102, data movement engine 106, or another hardware component can populate the runtime value based on one or more of an input sequence length, a tensor dimension, a tile dimension, a batch size, and runtime-generated metadata.

FIG. 7C illustrates a patched task descriptor, according to some examples of the disclosure. Link agent 162 can generate the patched task descriptor by replacing SRC_DIM_SIZE[1] with the runtime value read from MEM[0x4000]. In the illustrated example, SRC_DIM_SIZE[1] is resolved to 16. This operation can be represented by the following pseudocode:

If TASK.*_DYN_SIZE[x] → RUNTIME.*_DIM_SIZE[x] =
MEM[TASK.*_DIM_SIZE[x]]

In this pseudocode, “*” can correspond to a source-side prefix or a destination-side prefix, “x” can identify a dimension, TASK.*_DYN_SIZE[x] can correspond to an enable indicator for dynamic dimension size patching, TASK.*_DIM_SIZE[x] can correspond to a dimension size field before patching, and RUNTIME.*_DIM_SIZE[x] can correspond to the resolved dimension size value used by channel 164 to execute the data movement operation. In FIGS. 7A-7C, SRC_DYN_SIZE[1] corresponds to TASK.*_DYN_SIZE[x], SRC_DIM_SIZE[1] before patching stores pointer 0x4000, and SRC_DIM_SIZE[1] in the patched task descriptor stores resolved value 16.

After patching, SRC_DYN_SIZE[1] remains set to 1, and SRC_STRIDE[1], SRC_WIDTH, SADDR, and DADDR remain 128 B, 64 B, 0xA000, and 0xB000, respectively. Channel 164 can use the patched task descriptor to generate a source-side address pattern in which a 64-byte linear transfer is performed according to a dimension [1] loop that repeats 16 times with a 128-byte stride. Thus, the number of source-side loop iterations can be determined at runtime while the stride, width, source address, and destination address remain statically encoded for this example.

Although FIGS. 7A-7C show SRC_DIM_SIZE[1] storing pointer 0x4000 and being patched with the runtime value stored at address 0x4000, the runtime value shown in FIG. 7B is not limited to use with index [1]. The same mechanism may be applied to any dimension size field that stores a pointer to a runtime value, including a source-side dimension size field, a destination-side dimension size field, or both. For example, entries of dynamic field entries 210 may correspond to one or more of source dimension size fields, destination dimension size fields, loop count fields, repetition count fields, tile dimension fields, tensor dimension fields, and nested-loop control fields. A dimension size field for one index may point to one runtime value, a dimension size field for another index may point to a different runtime value, or multiple dimension size fields for the same or different indices may point to a shared runtime value. In this way, different dimensions may be independently patched, jointly patched through a shared runtime value, or left fixed as compile-time values.

Dynamic dimensionality patching allows a compiled task descriptor to express a multi-dimensional address pattern while leaving one or more loop bounds unresolved until execution. For example, a compiler may encode SRC_STRIDE[1], SRC_WIDTH, SADDR, and DADDR in the task descriptor while encoding SRC_DIM_SIZE[1] as a pointer to a runtime value. Updating the runtime value at address 0x4000 can then change the number of loop iterations used by the corresponding data movement operation without rewriting the stored task descriptor. When multiple task descriptors reference the same runtime dimension size value, updating that runtime value can change resolved dimension sizes for multiple corresponding data movement tasks, allowing a group of related tasks to be tuned together through shared runtime information.

The specific field names and values shown in FIGS. 7A-7C are illustrative. SRC_DYN_SIZE[1] can be implemented as one or more of a flag, a bit in a bitmap, a descriptor field, a code, and a configuration value indicating that one or more dimension size fields are dynamic. SRC_DIM_SIZE[1] can be replaced by any descriptor field that encodes a source-side dimension size, a destination-side dimension size, a loop count, a repetition count, a tensor dimension, or a tile dimension. Address 0x4000 and runtime value 16 are examples used to illustrate direct replacement patching. In other examples, link agent 162 can resolve dimension size fields using different pointer values, different runtime values, relative pointers, shared parameter table entries, or hardware computations that use runtime values to generate resolved dimension size values.

### Dynamic Address Patching

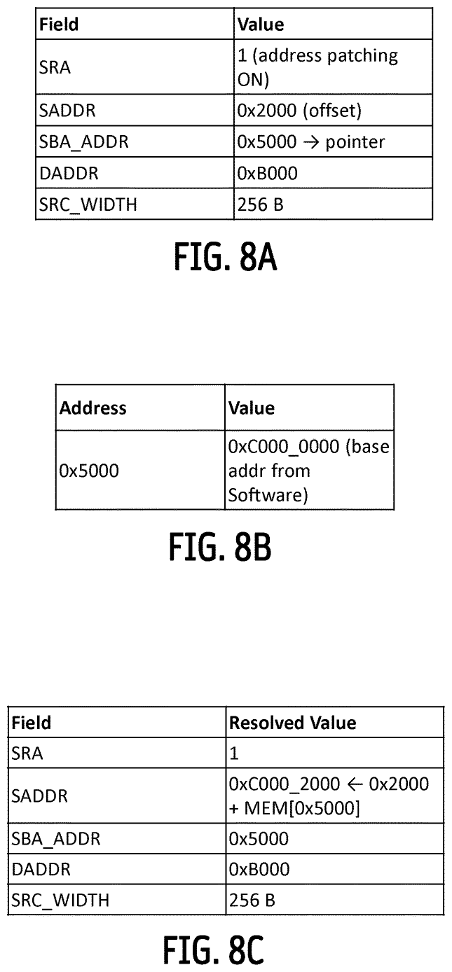

FIGS. 8A-8C illustrate an example of dynamic address patching, according to some examples of the disclosure. In the example of FIGS. 8A-8C, a task descriptor includes an address field that stores an offset and a base-address pointer field that stores a pointer to a runtime base address value. Link agent 162 can detect that address patching is enabled, read the runtime base address value from a memory location identified by the base-address pointer field, and generate a patched task descriptor in which the address field is replaced with a resolved runtime address. Channel 164 can then execute the corresponding data movement operation according to the patched task descriptor.

FIG. 8A illustrates an example task descriptor having a dynamic address field, according to some examples of the disclosure. The task descriptor includes SRA, SADDR, SBA_ADDR, DADDR, and SRC_WIDTH. SRA has a value of 1, indicating that source relative address patching is enabled. SADDR has a value of 0x2000, which can be interpreted as an offset when SRA indicates that source address patching is enabled. SBA_ADDR has a value of 0x5000 and can be interpreted as a pointer to a memory location storing a runtime source base address value. DADDR has a value of 0xB000, and SRC_WIDTH has a value of 256 B. In this example, DADDR and SRC_WIDTH remain statically encoded, while SADDR is resolved at runtime using the offset in SADDR and the runtime base address value identified by SBA_ADDR.

FIG. 8B illustrates one or more runtime values, according to some examples of the disclosure. In FIG. 8B, a runtime base address value of 0xC000_0000 is stored at address 0x5000. The runtime base address value can be provided by software 196, firmware, a memory manager, an operating system component, data movement engine 106, or a hardware component that determines where a source buffer is located for a particular execution. For example, software 196 may know a base address of a buffer allocated for a neural network inference request, while a compiled task descriptor may encode an offset into that buffer. Runtime field patching 142 can combine the runtime base address value with the descriptor-encoded offset to produce the resolved source address used by channel 164.

FIG. 8C illustrates a patched task descriptor, according to some examples of the disclosure. Link agent 162 can generate the patched task descriptor by computing a resolved value for SADDR based on the offset stored in SADDR and the runtime base address value read from MEM[0x5000]. In the illustrated example, SADDR is resolved to 0xC000_2000 based on 0x2000+MEM[0x5000]. This operation can be represented by the following pseudocode:

If TASK.RA == 1 → RUNTIME._ADDR = TASK.*_ADDR +
MEM[TASK.*BA_ADDR]

In this pseudocode, “*” can correspond to a source-side prefix, a destination-side prefix, or a link-address prefix. TASK.RA can correspond to an enable indicator for relative address patching, TASK._ADDR can correspond to an address field that stores an offset before patching, TASK.BA_ADDR can correspond to a base-address pointer field, and RUNTIME._ADDR can correspond to the resolved runtime address used for task execution. In FIGS. 8A-8C, SRA corresponds to TASK.*RA, SADDR before patching stores offset 0x2000, SBA_ADDR stores pointer 0x5000, and SADDR in the patched task descriptor stores resolved value 0xC000_2000.

After patching, SRA remains set to 1, SBA_ADDR remains 0x5000, DADDR remains 0xB000, and SRC_WIDTH remains 256 B. Channel 164 can use the patched task descriptor to execute a data movement operation in which source-side data is read from a runtime-resolved source address and transferred according to SRC_WIDTH. The address patching operation therefore allows a compiled descriptor to encode a relative location, such as an offset into a buffer, while allowing the actual base address of the buffer to be supplied at runtime.

Although FIGS. 8A-8C show source address patching for SADDR, the same approach may be applied to one or more of a source address field, a destination address field, and a link address field. For example, a destination relative address enable indicator may indicate that a destination address field stores an offset and that a destination base-address pointer field identifies a runtime destination base address value. A link relative address enable indicator may indicate that a link address field stores an offset and that a link base-address pointer field identifies a runtime link base address value. In the link address case, the resolved runtime address can identify a next task descriptor in a linked list, allowing a compiled list of task descriptors to be relocated in memory by updating a runtime base address value rather than rewriting link address fields in the stored task descriptors.

Dynamic address patching can be useful when a compiler can determine a relative layout of data structures but cannot determine absolute memory locations until runtime. For example, a task descriptor may encode an offset into one or more of an activation buffer, a weight buffer, a key-value cache buffer, an intermediate tensor buffer, and a descriptor list, while software 196 or another runtime component supplies a base address for the corresponding allocation. This allows the same compiled descriptor to be reused across different memory allocations, inference requests, batch configurations, or buffer placements.

In some examples, multiple task descriptors may store pointers to the same runtime base address value. Updating that runtime base address value can change resolved addresses for multiple corresponding data movement tasks, allowing a group of related source addresses, destination addresses, or link addresses to be relocated together. In some examples, different address fields may point to different runtime base address values, allowing source buffers, destination buffers, and descriptor lists to be relocated independently. Thus, dynamic address patching can support both shared relocation through a common runtime base address value and independent relocation through different runtime base address values.

The specific field names and values shown in FIGS. 8A-8C are illustrative. SRA can be implemented as one or more of a flag, a bit in a bitmap, a descriptor field, a code, and a configuration value indicating that a corresponding address field is to be resolved using a runtime base address value. SADDR can be replaced by any address field that stores an offset, and SBA_ADDR can be replaced by any base-address pointer field that identifies a runtime base address value. Address 0x5000, offset 0x2000, runtime base address value 0xC000_0000, and resolved address 0xC000_2000 are examples used to illustrate additive patching. In other examples, link agent 162 can resolve address fields using different offsets, different base address values, relative pointers, shared parameter table entries, or hardware computations that use runtime values to generate resolved address values.

### Dynamic Task Skip

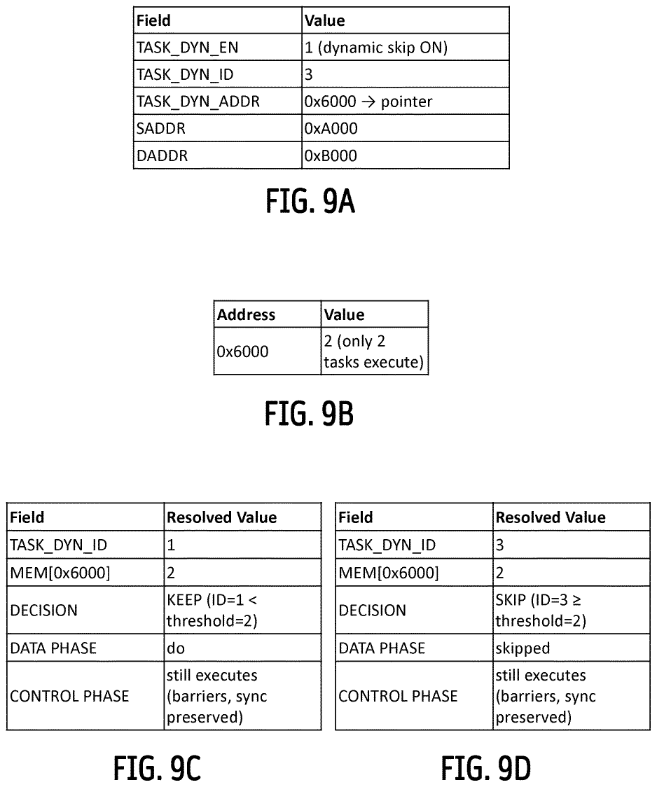

FIG. 9A illustrates a task descriptor having a dynamic skip field, according to some examples of the disclosure. The task descriptor includes TASK_DYN_EN, TASK_DYN_ID, TASK_DYN_ADDR, SADDR, and DADDR. TASK_DYN_EN has a value of 1, indicating that dynamic skip processing is enabled for the corresponding data movement task. TASK_DYN_ID has a value of 3, which can identify the task, a relative position of the task in a task sequence, or a task index used for comparison with a runtime threshold value. TASK_DYN_ADDR has a value of 0x6000 and can be interpreted as a pointer to a memory location storing the runtime threshold value. SADDR has a value of 0xA000 and DADDR has a value of 0xB000, which can identify source and destination addresses for the data movement operation.

FIG. 9B illustrates one or more runtime values, according to some examples of the disclosure. In FIG. 9B, a runtime threshold value of 2 is stored at address 0x6000. The runtime threshold value can indicate how many tasks in a sequence are to perform their data phases for a particular runtime execution. For example, the runtime threshold value may be based on one or more of an input sequence length, a prompt length, a batch size, a tensor shape, and a selected graph branch. The runtime threshold value can be stored in runtime fields storage 192 of FIG. 1, a parameter table, internal memory 104, external memory 110, memory 306, or a combination thereof. In some examples, multiple task descriptors can store a pointer to address 0x6000, such that the same runtime threshold value controls dynamic skip decisions for multiple corresponding data movement tasks.

Link agent 162 can evaluate dynamic skip by reading the runtime threshold value identified byTASK_DYN_ADDR and comparing TASK_DYN_ID with the runtime threshold value. This operation can be represented by the following pseudocode:

```
if DESCRIPTOR.TASK_DYN_EN == 0:
  execute data phase
else:
if MEM[DESCRIPTOR.TASK_DYN_ADDR] >
DESCRIPTOR.TASK_DYN_ID:
  execute data phase
else:
  skip data phase
```

In this pseudocode, DESCRIPTOR.TASK_DYN_EN can correspond to TASK_DYN_EN, DESCRIPTOR.TASK_DYN_ADDR can correspond to TASK_DYN_ADDR, DESCRIPTOR.TASK_DYN_ID can correspond to TASK_DYN_ID, and MEM[DESCRIPTOR.TASK_DYN_ADDR] can correspond to the runtime threshold value stored at the memory location identified by TASK_DYN_ADDR. Thus, in the illustrated example, link agent 162 can read MEM[0x6000] to obtain the runtime threshold value of 2 and can compare that runtime threshold value with TASK_DYN_ID.

FIG. 9C illustrates a patched task descriptor, according to some examples of the disclosure. FIG. 9C shows an example in which TASK_DYN_ID is 1 and MEM[0x6000] is 2. Because TASK_DYN_ID is less than the runtime threshold value, the decision is to KEEP, and the data phase is performed. In this example, channel 164 can execute the data phase of the data movement operation, such as by moving data from a source address to a destination address according to the corresponding task descriptor. The control phase also executes, including one or more of barrier operations, synchronization operations, semaphore operations, completion signaling, and graph-control signaling.

FIG. 9D illustrates a further patched task descriptor, according to some examples of the disclosure. FIG. 9D shows an example in which TASK_DYN_ID is 3 and MEM[0x6000] is 2. Because TASK_DYN_ID meets or exceeds the runtime threshold value, the decision is to SKIP, and the data phase is skipped. In this example, channel 164 can suppress data transfer activity associated with the task, such as source reads, destination writes, address generation for a data transfer, or request generation for a data transfer. However, the control phase still executes, including one or more of barrier operations, synchronization operations, semaphore operations, completion signaling, and graph-control signaling.

Preserving the control phase while skipping the data phase allows a compiled task graph to maintain its ordering, dependency, and synchronization semantics even when data movement is not needed for a particular task. For example, a compiler may generate a sequence of tasks for a maximum supported runtime condition, while software 196 writes a smaller runtime threshold value into runtime fields storage 192 for a particular execution. Tasks having task identifiers below the runtime threshold value can perform their data phases, while tasks having task identifiers that meet or exceed the runtime threshold value can skip their data phases but still participate in the control structure of the graph. This allows data movement to scale with runtime conditions without requiring software 196 to rewrite stored task descriptors or rebuild graph connectivity.

Dynamic skip differs from dynamic transfer size, dynamic dimensionality, and dynamic address patching in that dynamic skip may determine whether a data phase is performed rather than replacing a field with a runtime value used directly as an execution parameter. In some examples, TASK_DYN_EN can enable dynamic skip processing, TASK_DYN_ID can identify the task for threshold comparison, and TASK_DYN_ADDR can identify the runtime threshold value. Link agent 162 can generate a skip data phase indication based on the comparison, and task descriptor buffer 404 can store the skip data phase indication with the corresponding task descriptor, mark the corresponding task as not requiring data transfer, or provide task-ready information for control-phase processing. Task descriptor fetch controller 402 can use the skip data phase indication to proceed to a next task descriptor or coordinate task-ready signaling, while channel 164 can avoid performing data transfer for the skipped task.

The specific field names and values shown in FIGS. 9A-9D are illustrative. TASK_DYN_EN can be implemented as one or more of a flag, a bit in a bitmap, a descriptor field, a code, and a configuration value indicating that dynamic skip processing is enabled. TASK_DYN_ID can be implemented as one or more of a task identifier, task index, sequence position, ordering value, and descriptor number. TASK_DYN_ADDR can store an absolute pointer, relative pointer, table index, handle, or value resolved relative to a base address to locate the runtime threshold value. Although FIGS. 9A-9D compare TASK_DYN_ID with a runtime threshold value, dynamic skip decisions may also be based on another hardware-resolvable condition involving a task identifier, runtime value, descriptor field, configuration value, or a combination thereof.

### Multi-Dimensional Address Generation

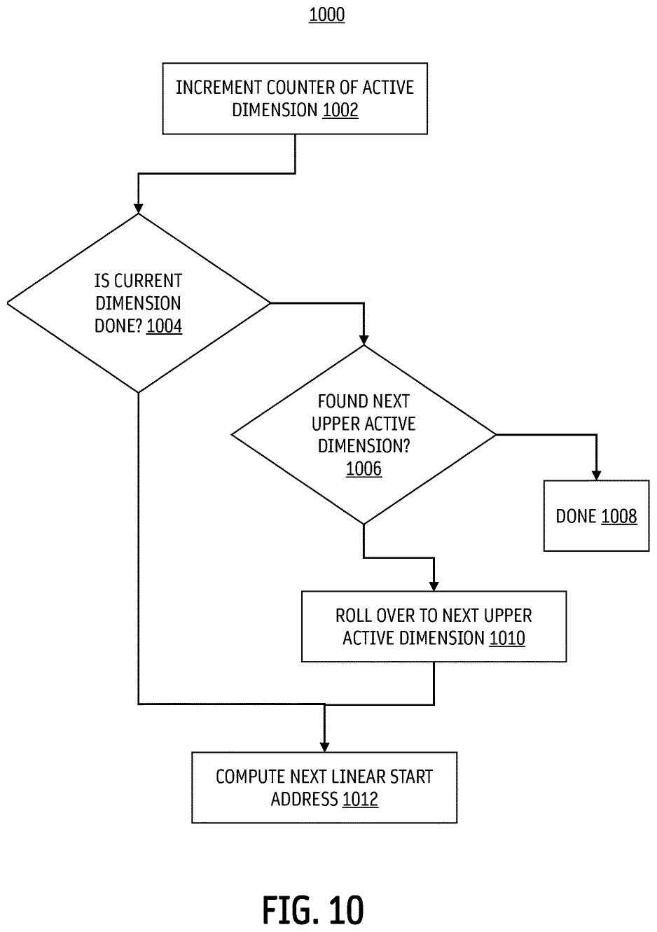

FIG. 10 illustrates method 1000 for address generation, according to some examples of the disclosure. Method 1000 can be performed by channel 164 of FIG. 4, read address pattern generation 410 of FIG. 4, write address pattern generation 430 of FIG. 4, or a combination thereof. Method 1000 can be used to generate a sequence of linear start addresses for a multi-dimensional data movement operation. Each linear start address can identify a beginning address for a contiguous portion of the data movement operation, and a separate request-generation portion of channel 164 can generate one or more memory access cycles to transfer a WIDTH amount of data beginning at that linear start address.

Method 1000 can be performed after link agent 162 provides channel 164 with a task descriptor, a patched task descriptor, or resolved task information. The task descriptor can define a multi-dimensional addressing pattern using one or more of an address field, a width field, one or more dimension size fields, and one or more stride fields. The address field can identify an initial byte address for the pattern. The width field can identify a linear portion of the transfer, such as an amount of contiguous bytes to be read or written for an innermost transfer segment. Each dimension size field can identify a number of times a corresponding dimension is repeated. Each stride field can identify an address offset applied between iterations of a corresponding dimension. One or more of these values may be fixed at compile time, patched using runtime field patching 142, or computed from a runtime value before method 1000 is performed.

Method 1000 can be used independently for source-side address generation and destination-side address generation. For example, read address pattern generation 410 can perform method 1000 using source-side parameters, such as SADDR, SRC_WIDTH, SRC_DIM_SIZE[x], and SRC_STRIDE[x]. Write address pattern generation 430 can perform method 1000 using destination-side parameters, such as DADDR, DST_WIDTH, DST_DIM_SIZE[x], and DST_STRIDE[x]. Source-side and destination-side address patterns may be different from each other, allowing channel 164 to read data according to one multi-dimensional pattern and write data according to another multi-dimensional pattern. In some examples, the task descriptor can be constructed so that total bytes read and total bytes written are consistent for the data movement operation.

Before or as part of method 1000, channel 164 can load tracker state for the multi-dimensional addressing pattern. The tracker state can include, for each dimension, a base address value, a repetition counter value, a dimension size value, and a stride value. In some examples, all dimensions can initially use the same start base address, while each dimension uses a dedicated size iterator value corresponding to that dimension. A dimension having a zero iteration count can be marked as disabled so that the dimension does not contribute to the generated address pattern. Channel 164 can also store an index of a lowest dimension that is not disabled, and that lowest enabled dimension can act as an initial active dimension for address-pattern calculation.

In 1002, channel 164 increments a counter of an active dimension. Performing 1002 can include updating a repetition counter associated with the currently selected dimension of the multi-dimensional address pattern. In some examples, the active dimension is the lowest active dimension, such as the lowest indexed dimension that is enabled and currently being processed. Incrementing the counter of the active dimension can occur after a linear start address has been consumed for a transfer segment. In some implementations, channel 164 may track the repetition counter as an incrementing counter, a decrementing counter, a remaining-count value, or another state value that indicates progress through the repetitions of the active dimension.

In 1004, channel 164 determines whether the current dimension is done. Performing 1004 can include comparing the counter of the active dimension with a dimension size, loop count, repetition count, or remaining-count value associated with the active dimension. The dimension size may be a compile-time value encoded in the task descriptor or a runtime-resolved value generated by link agent 162. For example, the dimension size may be a runtime value patched into a dimension size field using the dynamic dimensionality mechanism described with respect to FIGS. 7A-7C. If the current dimension is not done, channel 164 can continue address generation for the current active dimension and proceed toward computing a next linear start address in 1012. If the current dimension is done, channel 164 can determine whether a rollover to an upper active dimension is needed.

In 1006, channel 164 determines whether a next upper active dimension is found. Performing 1006 can include searching dimensions above the current dimension to identify a next dimension that has a non-zero repetition count and remaining iterations. For example, when a current dimension K completes, channel 164 can search for a next upper dimension N, where N is greater than K and has a non-zero repetition count. Performing 1006 can include skipping dimensions that are disabled, dimensions having zero size, dimensions that have completed all repetitions, and dimensions that are not used by the current task descriptor. Searching for the next upper active dimension allows the address-generation logic to represent nested-loop behavior without requiring a separate task descriptor for each linear transfer segment.

If no next upper active dimension is found in 1006, channel 164 determines that address generation is done in 1008. Performing 1008 can include determining that the highest enabled dimension for the task has completed all programmed or runtime-resolved iterations. In some examples, done in 1008 can cause channel 164 to stop generating additional read linear start addresses, write linear start addresses, data read requests, data write requests, or a combination thereof. Done in 1008 can also indicate that the data phase of the corresponding data movement operation has completed, allowing channel 164, link agent 162, or another portion of data movement engine 106 to perform one or more post-data control operations.

If a next upper active dimension is found in 1006, channel 164 performs rollover to the next upper active dimension in 1010. Performing 1010 can include selecting the next upper dimension N, incrementing or updating the repetition state for dimension N, applying a stride associated with dimension N, and resetting state for lower dimensions. For example, after dimension K completes, channel 164 can reload state for dimensions below dimension N, such as dimensions 0 through N−1, using task-programmed or runtime-resolved repetition counter values. Channel 164 can also set base addresses for the lower dimensions using a base address associated with the selected dimension N, so that the lower dimensions restart from the correct address location for the next iteration of the upper dimension. This rollover process implements nested-loop address behavior in hardware.

In 1012, channel 164 computes a next linear start address. Performing 1012 can include applying a stride value to a current address, updating an accumulated address offset, combining a base address with one or more dimension-dependent offsets, or selecting an address state corresponding to the active dimension. In some examples, channel 164 can use a single signed adder to compute the next linear start address, apply positive stride values, apply negative stride values, and reduce hardware cost relative to implementations using multiple dedicated adders. A signed stride can allow the address pattern to move forward or backward in memory, which can support one or more of strided access, reversed traversal, gather patterns, scatter patterns, and tensor-layout transformations. The computed next linear start address can then be provided to read request generation 420 or write request generation 440, which can generate memory access cycles for the corresponding WIDTH portion of the transfer.

Channel 164 can perform method 1000 in a pipelined manner. For example, while a current linear portion of a transfer is being processed by read request generation 420 or write request generation 440, the address-tracking logic can increment a dimension counter in 1002, determine whether the current dimension is done in 1004, search for a next upper active dimension in 1006, perform rollover in 1010 if needed, and compute a next linear start address in 1012. In some examples, the logic can perform one address-iteration update per clock cycle. Selecting the next upper dimension can also be performed while the last iteration of the current dimension is being processed, allowing channel 164 to sustain back-to-back throughput for successive linear start addresses.

Method 1000 can operate on runtime-resolved addressing parameters without requiring channel 164 to distinguish whether the parameters were originally static or dynamic. For example, a width used to determine the amount of data in each linear transfer segment may be patched using the dynamic transfer size mechanism described with respect to FIGS. 6A-6C. A dimension size used in 1004 may be patched using the dynamic dimensionality mechanism described with respect to FIGS. 7A-7C. A source address, destination address, or base address used in 1012 may be patched using the dynamic address patching mechanism described with respect to FIGS. 8A-8C. After link agent 162 resolves these values, channel 164 can execute method 1000 using the resolved task information as a normal task configuration.

Method 1000 allows a complex data movement pattern to be represented by a compact task descriptor rather than by a large number of simple linear data movement tasks. Channel 164 can maintain dimension state, apply strides, handle disabled dimensions, roll over completed dimensions, and compute each next linear start address in hardware. When one or more task parameters are patched at runtime, the same compiled task descriptor can be tuned for a particular execution condition, such as a sequence length, tensor shape, batch size, tile size, buffer location, or memory layout. This combination of multi-dimensional address generation and runtime-resolved task parameters can reduce descriptor storage, reduce descriptor fetch overhead, and allow data movement to scale with runtime execution conditions.

### Example Methods for Operating a Data Movement Engine

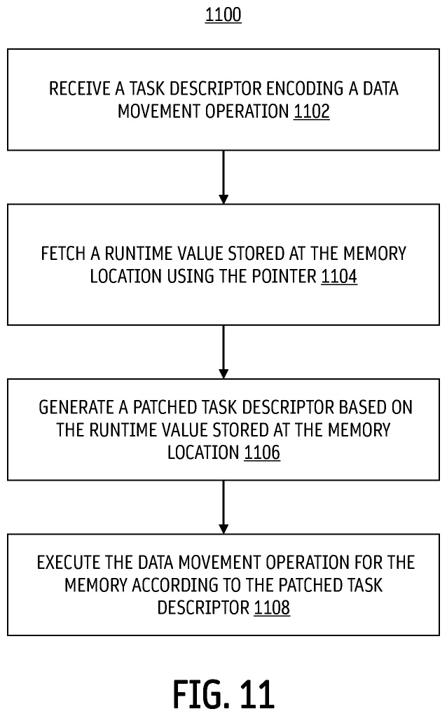

FIG. 11 is a flow diagram illustrating method 1100 for operating a data movement engine, according to some examples of the disclosure. Method 1100 can be performed by data movement engine 106, link agent 162, channel 164, runtime field patching 142, or a combination thereof. Method 1100 can be performed during execution of a neural network model by NN hardware accelerator 188, such as when compute engines 102 use data movement engine 106 to move data to, from, or within memory for inference. In some examples, method 1100 can allow a compiled task descriptor to include a field that stores a pointer to a memory location storing a runtime value, such that the data movement operation can be adapted to runtime execution conditions without modifying the stored task descriptor.

Before, during, or in connection with method 1100, software 196, firmware, compute engines 102, data movement engine 106, or a combination thereof can populate a parameter table in memory with runtime values. The parameter table can correspond to runtime fields storage 192, and the runtime values can include values based on runtime execution of a neural network model. For example, a runtime value can be based on one or more of an input sequence length, a prompt length, a batch size, a tensor shape, and a memory allocation. In some examples, multiple task descriptors can include fields that store a pointer to the same memory location in the parameter table, so that updating a single runtime value can change resolved execution parameters of multiple corresponding data movement tasks.

In 1102, link agent 162 receives a task descriptor encoding a data movement operation. Performing 1102 can include receiving a task descriptor from task descriptor storage 190, internal memory 104, external memory 110, memory 306, or a combination thereof. The task descriptor can include one or more fields encoding parameters of the data movement operation, such as one or more of a source address, a destination address, a transfer size, a dimension size, a stride, and a link address. In some examples, the task descriptor includes a field that stores a pointer to a memory location rather than a compile-time execution value. In some examples, link agent 162 can detect that the field stores the pointer based on an enable indicator in the task descriptor, such as one or more of a flag, a bitmap, a code, and a descriptor field.

In 1104, link agent 162 fetches a runtime value stored at the memory location using the pointer. Performing 1104 can include issuing a field read request to the memory location indicated by the pointer and receiving field read data that includes the runtime value. The pointer can be an absolute pointer or a relative pointer, such as an offset, index, or displacement resolved relative to a base address. In some examples, the runtime value can be fetched from a parameter table that stores multiple runtime values for a neural network execution. In some examples, the runtime value can be a transfer size value, a dimension size value, a threshold value, a base address value, a stride value, a task-control value, or another value used to resolve an execution parameter of the data movement operation.

In 1106, link agent 162 generates a patched task descriptor based on the runtime value stored at the memory location. Performing 1106 can include replacing a field of the task descriptor with the runtime value read in 1104. For example, if the field is a transfer size field encoding a number of bytes to transfer, link agent 162 can replace the transfer size field with the runtime value. If the field is a dimension size field encoding a repetition count of a loop in a multi-dimensional addressing pattern, link agent 162 can replace the dimension size field with the runtime value. In some examples, the dimension size field can correspond to one dimension of a plurality of dimensions, and different dimension size fields can be independently patched, jointly patched using a shared runtime value, or left as compile-time values.

Generating the patched task descriptor in 1106 can also include computing a resolved value based on the runtime value and a value encoded in the task descriptor. For example, if the field is a source address field storing an offset and the runtime value is a base address value, link agent 162 can compute a sum of the offset and the base address value and replace the source address field with the sum. Similarly, if the field is a destination address field storing an offset and the runtime value is a base address value, link agent 162 can compute a sum of the offset and the base address value and replace the destination address field with the sum. If the field is a link address field storing an offset that points to a next task descriptor in a linked list, link agent 162 can compute a sum of the offset and the base address value and replace the link address field with the sum, thereby allowing a linked list of task descriptors to be relocated using a runtime base address value.

In some examples, method 1100 can include generating a further patched task descriptor based on a further task descriptor having a further field that stores a pointer to the same memory location. For example, link agent 162 can process a first task descriptor having a field that points to a runtime value in runtime fields storage 192 and can also process a second task descriptor having a further field that points to the same runtime value. Updating the runtime value can therefore change resolved execution parameters for both task descriptors. This allows related data movement tasks to be tuned together through shared runtime information, while reducing descriptor-specific update overhead.

In some examples, method 1100 can support dynamic skip processing. For example, the task descriptor received in 1102 can include a task identifier, and the runtime value fetched in 1104 can be a threshold value. Link agent 162, channel 164, or a combination thereof can determine whether the task identifier meets or exceeds the threshold value. If the task identifier meets or exceeds the threshold value, executing the data movement operation can include skipping a data phase of the data movement operation. In some examples, a runtime value of zero for a transfer size field can also cause the data phase to be skipped. Even when the data phase is skipped, a control phase of the data movement operation can still execute, including one or more of synchronization operations, barrier updates, semaphore operations, interrupt generation, completion signaling, and graph-control signaling.

In 1108, channel 164 executes the data movement operation for the memory according to the patched task descriptor. Performing 1108 can include generating read address patterns, generating write address patterns, issuing read requests, issuing write requests, transferring data between a source and a destination, performing synchronization operations, or generating completion signaling. In some examples, channel 164 can execute a multi-dimensional data movement operation according to resolved values in the patched task descriptor, including runtime-resolved transfer sizes, runtime-resolved dimension sizes, and runtime-resolved addresses. Because link agent 162 generates the patched task descriptor before channel 164 executes the data movement operation, channel 164 can process the resolved task information without determining whether a particular execution parameter originated as a compile-time value or as a runtime value fetched using a pointer.

Method 1100 can support runtime patching of task descriptors for neural network inference while preserving a compiled descriptor structure. A field of a task descriptor can selectively store a pointer in lieu of a compile-time value, link agent 162 can fetch a runtime value using the pointer, and link agent 162 can generate a patched task descriptor using direct replacement, additive patching, dynamic skip evaluation, or a combination thereof. The same framework can support transfer size patching, dimensionality patching, source address patching, destination address patching, link address patching, and reuse of shared runtime values across multiple task descriptors. This allows data movement operations to adapt to runtime execution parameters, such as sequence length or buffer location, while reducing software patching of stored descriptors.

### Exemplary Computing Device

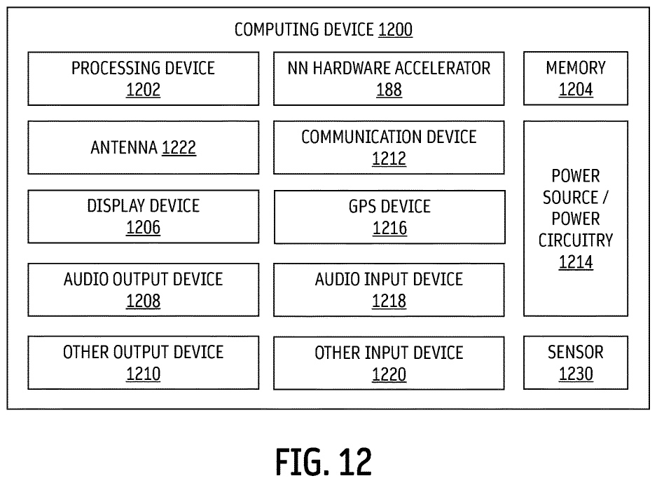

FIG. 12 is a block diagram of an apparatus or a system, e.g., an exemplary computing device 1200, according to some examples of the disclosure. One or more computing devices 1200 may be used to implement the functionalities described with the FIGS. and herein. A number of components are illustrated in the FIGS. that can be included in computing device 1200, but any one or more of these components may be omitted or duplicated, as suitable for the application. In some examples, some or all of the components included in computing device 1200 may be attached to one or more motherboards. In some examples, some or all of these components are fabricated onto a single system-on-chip die. Additionally, in various examples, computing device 1200 may not include one or more of the components illustrated in FIG. 12, and computing device 1200 may include interface circuitry for coupling to the one or more components. For example, computing device 1200 may not include a display device 1206, and may include display device interface circuitry (e.g., a connector and driver circuitry) to which a display device 1206 may be coupled. In another set of examples, computing device 1200 may not include an audio input device 1218 or an audio output device 1208 and may include audio input or output device interface circuitry (e.g., connectors and supporting circuitry) to which an audio input device 1218 or audio output device 1208 may be coupled.

Computing device 1200 may include a processing device 1202 (e.g., one or more processing devices, one or more of the same type of processing device, one or more of different types of processing devices). The processing device 1202 may include electronic circuitry that processes electronic data from data storage elements (e.g., registers, memory, resistors, capacitors, quantum bit cells) to transform that electronic data into other electronic data that may be stored in registers and/or memory. Examples of processing device 1202 may include a CPU, a GPU, a quantum processor, a machine learning processor, an artificial intelligence processor, a neural network processor, an artificial intelligence accelerator, an application-specific integrated circuit (ASIC), an analog signal processor, an analog computer, a microprocessor, a digital signal processor, a FPGA, a TPU, a data processing unit (DPU), etc.

In some examples, computing device 1200 may include NN hardware accelerator 188. NN hardware accelerator 188 can interface with processing device 1202 to accelerate inference, training, artificial intelligence, machine learning, graphics, signal processing, image processing, video processing, data processing, networking, security, compression, decompression, or suitable compute operations. In some examples, NN hardware accelerator 188 may be implemented as one or more of a neural network accelerator, artificial intelligence accelerator, machine learning accelerator, graphics processing unit, image signal processor, video processing unit, digital signal processor, data processing unit, infrastructure processing unit, network processing unit, security accelerator, cryptographic accelerator, compression accelerator, decompression accelerator, or suitable multi-tile or multi-agent processing device.

NN hardware accelerator 188 may include one or more components described with reference to FIGS. 1-11. For example, NN hardware accelerator 188 may include one or more compute engines 102, internal memory 104, data movement engine 106, configuration registers 154, link agent 162, channel 164, external memory interface 108, runtime field patching 142, checker 144, fetch 146, augment 148, task descriptor fetch controller 402, task descriptor buffer 404, read address pattern generation 410, read request generation 420, write address pattern generation 430, write request generation 440, or a combination thereof. In some examples, one or more of these components may be implemented in NN hardware accelerator 188 as hardware logic, firmware-controlled hardware, programmable interconnect logic, register-transfer-level circuitry, state machines, microcoded control logic, fixed-function data movement circuitry, programmable processing circuitry, or combinations thereof. In some examples, NN hardware accelerator 188 may implement runtime field patching 142 to generate patched task descriptors based on runtime values stored in memory, and channel 164 may execute data movement operations according to the patched task descriptors.

Computing device 1200 may include a memory 1204, which may itself include one or more memory devices such as volatile memory (e.g., DRAM), nonvolatile memory (e.g., ROM), HBM, flash memory, solid-state memory, and/or a hard drive. Memory 1204 includes one or more non-transitory computer-readable storage media. In some examples, memory 1204 may include memory that shares a die with the processing device 1202.

In some examples, memory 1204 includes one or more non-transitory computer-readable media storing instructions executable to perform operations described with reference to FIGS. 1-11 and herein. Memory 1204 may store instructions that generate inputs to NN hardware accelerator 188, including instructions for receiving or preparing neural network inputs, determining runtime execution parameters, determining a sequence length of an input prompt, determining a batch size, determining tensor shape information, allocating source buffers or destination buffers, populating runtime fields storage 192, populating a parameter table with runtime values, loading task descriptors into task descriptor storage 190, and submitting task descriptor addresses to data movement engine 106. Memory 1204 may also store instructions that process outputs from NN hardware accelerator 188, including instructions for receiving output tensors, post-processing inference results, updating application state, processing completion notifications from data movement engine 106, and initiating additional neural network execution tasks. The instructions stored in the one or more non-transitory computer-readable media may be executed by processing device 1202, by NN hardware accelerator 188, or by a combination thereof.

In some examples, memory 1204 may store data described with reference to FIGS. 1-11 and herein. For example, memory 1204 may store one or more of application data 194, runtime fields storage 192, task descriptor storage 190, compute engine data 198, descriptor 340, pointer 330, source 342, destination 344, data 334, task descriptors of linked list 200, runtime values of FIGS. 6B, 7B, 8B, and 9B, and values used by method 1100. Data stored in memory 1204 may include inputs and outputs for NN hardware accelerator 188, including input tensors, output tensors, input activations, output feature maps, weights of weight matrices, operation parameters, intermediate feature maps, model parameters, layer parameters, source addresses, destination addresses, transfer sizes, dimension sizes, stride values, task identifiers, threshold values, base address values, link addresses, memory attributes, task descriptors, patched task descriptors, and data movement descriptors. Memory 1204 may also store parameter tables that include runtime values referenced by fields of task descriptors, such that link agent 162 can fetch a runtime value using a pointer stored in a task descriptor and generate a patched task descriptor for execution by channel 164.

In some examples, computing device 1200 may include a communication device 1212 (e.g., one or more communication devices). For example, communication device 1212 may be configured for managing wired and/or wireless communications for the transfer of data to and from computing device 1200. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not include any wires, although in some examples they might not. Communication device 1212 may implement any of a number of wireless standards or protocols. Computing device 1200 may include an antenna 1222 to facilitate wireless communications and/or to receive other wireless communications (such as radio frequency transmissions). Computing device 1200 may include receiver circuits and/or transmitter circuits. In some examples, the communication device 1212 may manage wired communications, such as electrical, optical, or any other suitable communication protocols (e.g., Ethernet). As noted above, the communication device 1212 may include multiple communication chips. For instance, a first communication device 1212 may be dedicated to shorter-range wireless communications, such as Wi-Fi or Bluetooth, and a second communication device 1212 may be dedicated to longer-range wireless communications. In some examples, a first communication device 1212 may be dedicated to wireless communications, and a second communication device 1212 may be dedicated to wired communications.

Computing device 1200 may include power source/power circuitry 1214. The power source/power circuitry 1214 may include one or more energy storage devices (e.g., batteries or capacitors) and/or circuitry for coupling components of computing device 1200 to an energy source separate from computing device 1200 (e.g., DC power, AC power, etc.).

Computing device 1200 may include a display device 1206 (or corresponding interface circuitry, as discussed above). Display device 1206 may include any visual indicators, such as a heads-up display, a computer monitor, a projector, a touchscreen display, a liquid crystal display (LCD), a light-emitting diode display, or a flat panel display, for example.

Computing device 1200 may include an audio output device 1208 (or corresponding interface circuitry, as discussed above). The audio output device 1208 may include any device that generates an audible indicator, such as speakers, headsets, or earbuds, for example.

Computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

Computing device 1200 may include a GPS device 1216 (or corresponding interface circuitry, as discussed above). GPS device 1216 may be in communication with a satellite-based system and may receive the location of computing device 1200, as known in the art.

Computing device 1200 may include sensor 1230 (or one or more sensors). Computing device 1200 may include corresponding interface circuitry, as discussed above. Sensor 1230 may sense physical phenomena and translate the physical phenomenon into electrical signals that can be processed by, e.g., processing device 1202. Examples of sensor 1230 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1200 may include another output device 1210 (or corresponding interface circuitry, as discussed above). Examples of the other output device 1210 may include an audio codec, a video codec, a printer, a wired or wireless transmitter for providing information to other devices, haptic output device, gas output device, vibrational output device, lighting output device, home automation controller, or an additional storage device.

Computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1200 may have any desired form factor, such as a handheld or mobile computer system (e.g., a cell phone, a smartphone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or suitable networked computing component, a printer, a scanner, a monitor, a set-top box, an entertainment control unit, a vehicle control unit, a digital camera, a digital video recorder, an Internet-of-Things device, or a wearable computer system. In some examples, computing device 1200 may be any other electronic device that processes data.

### Select Examples

Example 1 provides a neural network accelerator including one or more compute engines; a memory accessible by the one or more compute engines; and a data movement engine to move data to and/or from the memory for executing a neural network model, the data movement engine including a link agent circuit to generate a patched task descriptor based on a task descriptor encoding a data movement operation and a runtime value stored in the memory, where the runtime value is stored in a memory location of the memory, and the task descriptor has a field that stores a pointer to the memory location of the memory; and a channel circuit to execute the data movement operation for the memory according to the patched task descriptor.

Example 2 provides the neural network accelerator of example 1, where the runtime value is based on an input parameter of the neural network model that is dependent on a runtime execution of the neural network model on the neural network accelerator.

Example 3 provides the neural network accelerator of example 2, where the input parameter is a sequence length of an input prompt to the neural network model.

Example 4 provides the neural network accelerator of any one of examples 1-3, where the link agent circuit is further to: detect that the field stores the pointer based on an enable indicator in the task descriptor, the enable indicator indicating that the field stores the pointer.

Example 5 provides the neural network accelerator of any one of examples 1-4, where the memory stores a parameter table having one or more runtime values at one or more memory locations.

Example 6 provides the neural network accelerator of any one of examples 1-5, where the link agent circuit is further to: generate a further patched task descriptor based on a further task descriptor encoding a data movement operation and the runtime value stored in the memory, where the further task descriptor has a further field that stores the pointer to the memory location of the memory.

Example 7 provides the neural network accelerator of any one of examples 1-6, where: the task descriptor further includes a task identifier; the runtime value is a threshold value; and the channel circuit executes the data movement operation by skipping a data phase of the data movement operation based on the task identifier meeting or exceeding the threshold value.

Example 8 provides the neural network accelerator of example 7, where the link agent circuit and the channel circuit execute a control phase of the data movement operation including one or more synchronization operations based on the task identifier meeting or exceeding the threshold value.

Example 9 provides the neural network accelerator of any one of examples 1-8, where: the field is a transfer size field encoding a number of bytes to transfer; and the link agent circuit generates the patched task descriptor by replacing the transfer size field with the runtime value.

Example 10 provides the neural network accelerator of example 9, where: the runtime value is zero; and the channel circuit executes the data movement operation by skipping a data phase of the data movement operation.

Example 11 provides the neural network accelerator of any one of examples 1-10, where: the field is a dimension size field encoding a repetition count of a loop in a multi-dimensional addressing pattern; and the link agent circuit generates the patched task descriptor by replacing the dimension size field with the runtime value.

Example 12 provides the neural network accelerator of example 11, where the dimension size field corresponds to a dimension of a plurality of dimensions.

Example 13 provides the neural network accelerator of any one of examples 1-12, where: the field is a source address field storing an offset; the runtime value is a base address value; and the link agent circuit generates the patched task descriptor by computing a sum of the offset and the base address value and replacing the source address field with the sum.

Example 14 provides the neural network accelerator of any one of examples 1-13, where: the field is a destination address field storing an offset; the runtime value is a base address value; and the link agent circuit generates the patched task descriptor by computing a sum of the offset and the base address value and replacing the destination address field with the sum.

Example 15 provides the neural network accelerator of any one of examples 1-14, where: the field is a link address field storing an offset, the link address field pointing to a next task descriptor in a linked list; the runtime value is a base address value; and the link agent circuit generates the patched task descriptor by computing a sum of the offset and the base address value, and replacing the link address field with the sum.

Example 16 provides an apparatus, including a link agent circuit, the link agent circuit to: fetch a task descriptor from a memory, the task descriptor including one or more fields encoding a data movement operation; detect that a field of the one or more fields stores a pointer to a memory location; read a runtime value from the memory location indicated by the pointer; and generate a patched task descriptor based on the runtime value; and a channel circuit coupled to the link agent circuit, the channel circuit to execute the data movement operation according to the patched task descriptor.

Example 17 provides the apparatus of example 16, where the link agent circuit detects that the field stores a pointer based on an enable indicator encoded in the task descriptor, the enable indicator indicating that the field stores the pointer in lieu of a compile-time value.

Example 18 provides the apparatus of example 16 or 17, where the link agent circuit fetches a further task descriptor from the memory, the further task descriptor including a further field storing the pointer to the memory location.

Example 19 provides the apparatus of any one of examples 16-18, where: the task descriptor further includes a task identifier and the runtime value is a threshold value; and the channel circuit executes the data movement operation by skipping a data phase of the data movement operation based on the task identifier meeting or exceeding the threshold value.

Example 20 provides the apparatus of example 19, where the link agent circuit and the channel circuit execute a control phase of the data movement operation including one or more synchronization operations based on the task identifier meeting or exceeding the threshold value.

Example 21 provides the apparatus of any one of examples 16-20, where: the field is a transfer size field encoding a number of bytes to transfer; and the link agent circuit generates the patched task descriptor by replacing the transfer size field in the patched task descriptor with the runtime value read from the memory location indicated by the pointer.

Example 22 provides the apparatus of example 21, where: the runtime value is zero; and the channel circuit executes the data movement operation by skipping a data phase of the data movement operation.

Example 23 provides the apparatus of any one of examples 16-22, where: the field is a dimension size field encoding a repetition count of a loop in a multi-dimensional addressing pattern; and the link agent circuit generates the patched task descriptor by replacing the dimension size field in the patched task descriptor with the runtime value.

Example 24 provides the apparatus of example 23, where the dimension size field corresponds to a dimension of a plurality of dimensions.

Example 25 provides the apparatus of any one of examples 16-24, where: the task descriptor includes a source address field storing an offset; the runtime value is a base address value; the link agent circuit is to compute a runtime source address value by adding the offset to the base address value read; and the link agent circuit generates the patched task descriptor by replacing the source address field in the patched task descriptor with the runtime source address value.

Example 26 provides the apparatus of any one of examples 16-25, where: the task descriptor includes a destination address field storing an offset; the runtime value is a base address value; the link agent circuit is to compute a runtime destination address value by adding the offset to the base address value read; and the link agent circuit generates the patched task descriptor by replacing the destination address field in the patched task descriptor with the runtime destination address value.

Example 27 provides the apparatus of example 16, where: the task descriptor includes a link address field storing an offset; the runtime value is a base address value; the link agent circuit is to compute a runtime link address value by adding the offset to the base address value read, the runtime link address value pointing to a next task descriptor in a linked list; and the link agent circuit generates the patched task descriptor by replacing the link address field in the patched task descriptor with the runtime link address value.

Example 28 provides the apparatus of any one of examples 16-27, where generating the patched task descriptor includes replacing the field with the runtime value read from the memory location.

Example 29 provides the apparatus of any one of examples 16-27, where generating the patched task descriptor includes computing a sum of a value stored in the field and the runtime value read from the memory location, and using the sum as a resolved value in the patched task descriptor.

Example 30 provides a method of operating a neural network accelerator, the method including receiving, by a link agent circuit of a data movement engine, a task descriptor encoding a data movement operation, the task descriptor having a field that stores a pointer to a memory location of a memory of the neural network accelerator; fetching, by the link agent circuit, a runtime value stored at the memory location using the pointer; generating, by the link agent circuit, a patched task descriptor based on the runtime value stored at the memory location; and executing, by a channel circuit of the data movement engine, the data movement operation for the memory according to the patched task descriptor.

Example 31 provides the method of example 30, where the runtime value is based on an input parameter of a neural network model.

Example 32 provides the method of example 31, where the input parameter is a sequence length of an input prompt to the neural network model.

Example 33 provides the method of any one of examples 31-32, further including populating a parameter table in the memory with one or more runtime values, where the one or more runtime values include the runtime value.

Example 34 provides the method of any one of examples 30-33, further including detecting, by the link agent circuit, that the field stores the pointer based on an enable indicator in the task descriptor.

Example 35 provides the method of any one of examples 30-34, further including generating, by the link agent circuit, a further patched task descriptor based on a further task descriptor having a further field that stores the pointer to the memory location.

Example 36 provides the method of any one of examples 30-35, where: the task descriptor further includes a task identifier; the runtime value is a threshold value; and executing the data movement operation includes skipping a data phase of the data movement operation based on the task identifier meeting or exceeding the threshold value.

Example 37 provides the method of example 36, further including executing a control phase of the data movement operation including one or more synchronization operations based on the task identifier meeting or exceeding the threshold value.

Example 38 provides the method of any one of examples 30-37, where: the field is a transfer size field encoding a number of bytes to transfer; and generating the patched task descriptor includes replacing the transfer size field with the runtime value.

Example 39 provides the method of example 38, where: the runtime value is zero; and executing the data movement operation includes skipping a data phase of the data movement operation.

Example 40 provides the method of any one of examples 30-39, where: the field is a dimension size field encoding a repetition count of a loop in a multi-dimensional addressing pattern; and generating the patched task descriptor includes replacing the dimension size field with the runtime value.

Example 41 provides the method of example 40, where the dimension size field corresponds to a dimension of a plurality of dimensions.

Example 42 provides the method of any one of examples 30-41, where: the field is a source address field storing an offset and the runtime value is a base address value; and generating the patched task descriptor includes computing a sum of the offset and the base address value and replacing the source address field with the sum.

Example 43 provides the method of any one of examples 30-42, where: the field is a destination address field storing an offset and the runtime value is a base address value; and generating the patched task descriptor includes computing a sum of the offset and the base address value and replacing the destination address field with the sum.

Example 44 provides the method of any one of examples 30-43, where: the field is a link address field storing an offset pointing to a next task descriptor in a linked list, and the runtime value is a base address value; and generating the patched task descriptor includes computing a sum of the offset and the base address value and replacing the link address field with the sum.

### Variations and Other Notes

Although the operations of the example method shown in and described with reference to FIGS. are illustrated as occurring once each and in a particular order, it will be recognized that some operations may be performed in any suitable order and repeated as desired. Furthermore, the operations illustrated in FIGS. may be combined or may include more or fewer details than described.

The various implementations described herein may refer to AI, machine learning, and deep learning. Deep learning may be a subset of machine learning. Machine learning may be a subset of AI. In cases where a deep learning model is mentioned, if suitable for a particular application, a machine learning model may be used instead. In cases where a deep learning model is mentioned, if suitable for a particular application, a digital signal processing system may be used instead.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A neural network accelerator comprising:
one or more compute engines;
a memory accessible by the one or more compute engines; and
a data movement engine to move data to and/or from the memory for executing a neural network model, the data movement engine comprising:
a link agent circuit to generate a patched task descriptor based on a task descriptor encoding a data movement operation and a runtime value stored in the memory, wherein the runtime value is stored in a memory location of the memory, and the task descriptor has a field that stores a pointer to the memory location of the memory; and
a channel circuit to execute the data movement operation for the memory according to the patched task descriptor.

2. The neural network accelerator of claim 1, wherein the runtime value is based on an input parameter of the neural network model that is dependent on a runtime execution of the neural network model on the neural network accelerator.

3. The neural network accelerator of claim 2, wherein the input parameter is a sequence length of an input prompt to the neural network model.

4. The neural network accelerator of claim 1, wherein the link agent circuit is further to:
detect that the field stores the pointer based on an enable indicator in the task descriptor, the enable indicator indicating that the field stores the pointer.

5. The neural network accelerator of claim 1, wherein the memory stores a parameter table having one or more runtime values at one or more memory locations.

6. The neural network accelerator of claim 1, wherein the link agent circuit is further to:
generate a further patched task descriptor based on a further task descriptor encoding a data movement operation and the runtime value stored in the memory, wherein the further task descriptor has a further field that stores the pointer to the memory location of the memory.

7. The neural network accelerator of claim 1, wherein:
the task descriptor further comprises a task identifier;
the runtime value is a threshold value; and
the channel circuit executes the data movement operation by skipping a data phase of the data movement operation based on the task identifier meeting or exceeding the threshold value.

8. The neural network accelerator of claim 7, wherein the link agent circuit and the channel circuit execute a control phase of the data movement operation comprising one or more synchronization operations based on the task identifier meeting or exceeding the threshold value.

9. The neural network accelerator of claim 1, wherein:
the field is a transfer size field encoding a number of bytes to transfer; and
the link agent circuit generates the patched task descriptor by replacing the transfer size field with the runtime value.

10. The neural network accelerator of claim 9, wherein:
the runtime value is zero; and
the channel circuit executes the data movement operation by skipping a data phase of the data movement operation.

11. The neural network accelerator of claim 1, wherein:
the field is a dimension size field encoding a repetition count of a loop in a multi-dimensional addressing pattern; and
the link agent circuit generates the patched task descriptor by replacing the dimension size field with the runtime value.

12. The neural network accelerator of claim 11, wherein the dimension size field corresponds to a dimension of a plurality of dimensions.

13. The neural network accelerator of claim 1, wherein:
the field is a source address field storing an offset;
the runtime value is a base address value; and
the link agent circuit generates the patched task descriptor by computing a sum of the offset and the base address value and replacing the source address field with the sum.

14. The neural network accelerator of claim 1, wherein:
the field is a destination address field storing an offset;
the runtime value is a base address value; and
the link agent circuit generates the patched task descriptor by computing a sum of the offset and the base address value and replacing the destination address field with the sum.

15. The neural network accelerator of claim 1, wherein:
the field is a link address field storing an offset, the link address field pointing to a next task descriptor in a linked list;
the runtime value is a base address value; and
the link agent circuit generates the patched task descriptor by computing a sum of the offset and the base address value, and replacing the link address field with the sum.

16. An apparatus, comprising:
a link agent circuit, the link agent circuit to:
fetch a task descriptor from a memory, the task descriptor comprising one or more fields encoding a data movement operation;
detect that a field of the one or more fields stores a pointer to a memory location;
read a runtime value from the memory location indicated by the pointer; and
generate a patched task descriptor based on the runtime value; and
a channel circuit coupled to the link agent circuit, the channel circuit to execute the data movement operation according to the patched task descriptor.

17. The apparatus of claim 16, wherein the link agent circuit detects that the field stores a pointer based on an enable indicator encoded in the task descriptor, the enable indicator indicating that the field stores the pointer in lieu of a compile-time value.

18. The apparatus of claim 16, wherein the link agent circuit fetches a further task descriptor from the memory, the further task descriptor comprising a further field storing the pointer to the memory location.

19. A method of operating a neural network accelerator, the method comprising:
receiving, by a link agent circuit of a data movement engine, a task descriptor encoding a data movement operation, the task descriptor having a field that stores a pointer to a memory location of a memory of the neural network accelerator;
fetching, by the link agent circuit, a runtime value stored at the memory location using the pointer;
generating, by the link agent circuit, a patched task descriptor based on the runtime value stored at the memory location; and
executing, by a channel circuit of the data movement engine, the data movement operation for the memory according to the patched task descriptor.

20. The method of claim 19, wherein the runtime value is based on an input parameter of a neural network model.
